(19) United States
(12) Patent Application Publication
(10) Pub. No.: US 2026/0246517 A1
(43) Pub. Date: Aug. 20, 2026

(54) EARLY CSI-RS MEASUREMENT AND CSI REPORTING

(71) Applicant: Samsung Electronics Co., Ltd., Suwon-si (KR)

(72) Inventors: Md. Saifur Rahman, Plano, TX (US); Eko Onggosanusi, Coppell, TX (US); Emad Nader Farag, Flanders, NJ (US); Dalin Zhu, Allen, TX (US)

(21) Appl. No.: 19/460,228

(22) Filed: Jan. 26, 2026

Related U.S. Application Data
(60) Provisional application No. 63/758,827, filed on Feb. 14, 2025.

(51) Int. Cl. H04B 7/06; H04W 74/0836

(52) U.S. Cl. CPC H04B 7/0626; H04W 74/0836

(57) ABSTRACT

Apparatuses and methods for early CSI-RS measurement and CSI reporting. A method performed by a user equipment (UE) includes receiving, in a first slot, a first information about a channel state information (CSI) report, receiving a second information about at least one of channel measurement reference signal (CMR) and interference measurement reference signal (IMR), and measuring the at least one of CMR and IMR. The method further includes determining the CSI report based on the measurement and transmitting the CSI report. The first slot is a second slot or D slots after the second slot, where D>0. The second slot is associated with a last step of an N-step random access channel (RACH) procedure, where Nϵ{2,4}.

### CROSS-REFERENCE TO RELATED AND CLAIM OF PRIORITY

The present application claims priority under 35 U.S.C. § 119(e) to U.S. Provisional Patent Application No. 63/758,827 filed on Feb. 14, 2025, which is hereby incorporated by reference in its entirety.

### TECHNICAL FIELD

The present disclosure relates generally to wireless communication systems and, more specifically, the present disclosure is related to apparatuses and methods for early channel state information (CSI) reference signal (RS) measurement and CSI reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to early CSI-RS measurement and CSI reporting.

In one embodiment, a user equipment (UE) is provided. The UE includes a transceiver configured to receive, in a first slot, a first information about a CSI report and receive a second information about at least one of channel measurement reference signal (CMR) and interference measurement reference signal (IMR). The UE further includes a processor operably coupled to the transceiver. The processor is configured to measure the at least one of CMR and IMR and determine the CSI report based on the measurement. The transceiver is further configured to transmit the CSI report. The first slot is a second slot or D slots after the second slot, where D>0. The second slot is associated with a last step of an N-step random access channel (RACH) procedure, where Nϵ{2,4}.

In another embodiment, a base station (BS) is provided. The BS includes a processor and a transceiver operably coupled to the processor. The transceiver is configured to transmit, in a first slot, a first information about a CSI report, transmit a second information about at least one of CMR and IMR, transmit the at least one of CMR and IMR, and receive the CSI report that is based on the at least one of CMR and IMR. The first slot is a second slot or D slots after the second slot, where D>0. The second slot is associated with a last step of an N-step RACH procedure, where Nϵ{2,4}.

In yet another embodiment, a method performed by a UE is provided. The method includes receiving, in a first slot, a first information about a CSI report, receiving a second information about at least one of CMR and interference IMR, and measuring the at least one of CMR and IMR. The method further includes determining the CSI report based on the measurement and transmitting the CSI report. The first slot is a second slot or D slots after the second slot, where D>0. The second slot is associated with a last step of an N-step RACH procedure, where Nϵ{2,4}.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates an example antenna port layout according to embodiments of the present disclosure;

FIG. 10 illustrates example radio access network (RAN) configurations according to embodiments of the present disclosure;

FIG. 11 illustrates an example primary synchronization signal (PSS)/secondary synchronization signal (SSS)/physical broadcast channel (PBCH) (SSB) block according to embodiments of the present disclosure;

FIG. 12 illustrates an example type-1 random access procedure according to embodiments of the present disclosure;

FIG. 13 illustrates an example type-2 random access procedure according to embodiments of the present disclosure;

FIG. 14 illustrates an example medium access control (MAC) random access response (RAR) (for type-1 random access procedure) according to embodiments of the present disclosure;

FIG. 15 illustrates an example fallback RAR (for type-2 random access procedure) according to embodiments of the present disclosure;

FIG. 16 illustrates an example success RAR (for type-2 random access procedure) according to embodiments of the present disclosure;

FIG. 17 illustrates an example antenna port layout according to embodiments of the present disclosure;

FIG. 18 illustrates an example of configuring a UE with a CSI report according to embodiments of the present disclosure;

FIG. 19 illustrates another example of configuring a UE with a CSI report according to embodiments of the present disclosure;

FIG. 20 illustrates an example of UE-sided CSI prediction according to embodiments of the present disclosure;

FIG. 21 illustrates an example of using a joint CSI trigger for both CMR/IMR measurement and CSI reporting according to embodiments of the present disclosure;

FIG. 22 illustrates an example where the CMR/IMR slot is the same as the CSI reference resource slot for CMR/IMR measurement and CSI reporting according to embodiments of the present disclosure;

FIG. 23 illustrates examples where separate triggers (DCIs) are received in the same slot and used for the CMR/IMR measurement and the CSI reporting according to embodiments of the present disclosure;

FIG. 24 illustrates examples where separate triggers (DCIs) are received in two different slots and used for the CMR/IMR measurement and the CSI reporting according to embodiments of the present disclosure;

FIG. 25 illustrates an example of measuring a CSI-RS burst according to embodiments of the present disclosure;

FIG. 26 illustrates an example of a timeline for a UE to receive nonzero power (NZP) CSI-RS bursts according to embodiments of the present disclosure;

FIG. 27 illustrates an example of determining a value of N₄ according to embodiments of the present disclosure;

FIG. 28 illustrates a timeline of example spatial-domain (SD) units and frequency-domain (FD) units according to embodiments of the present disclosure;

FIG. 29 illustrates an example antenna port-based/PG-based layout according to embodiments of the present disclosure;

FIG. 30 illustrates an example configuration for channel measurement according to embodiments of the present disclosure;

FIG. 31 illustrates an example of configuring a UE with a codebook for PMI calculation and reporting according to embodiments of the present disclosure;

FIG. 32 illustrates an example procedure for early CSI according to embodiments of the present disclosure;

FIG. 33 illustrates another example procedure for early CSI according to embodiments of the present disclosure; and

FIG. 34 illustrates an example method performed by a UE in a wireless communication system according to embodiments of the present disclosure.

### DETAILED DESCRIPTION

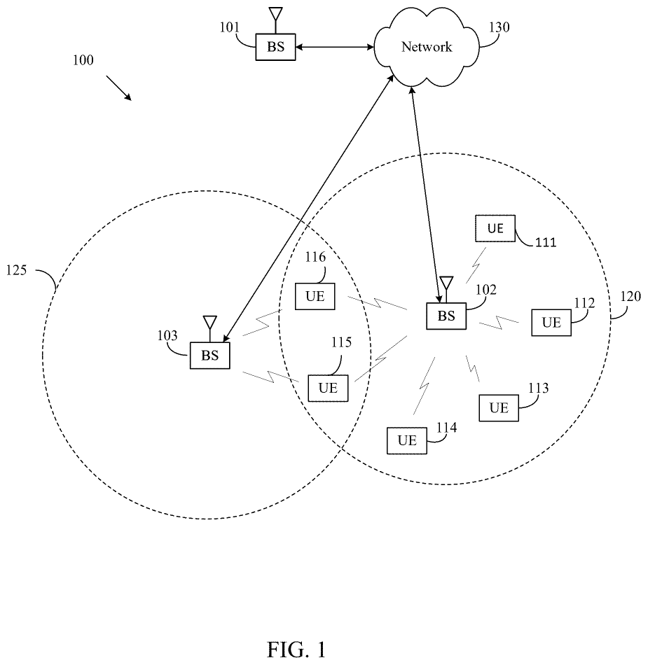

FIGS. 1-34 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 36.211 v17.3.0, “E-UTRA, Physical channels and modulation”; [REF 2]3GPP TS 36.212 v17.1.0, “E-UTRA, Multiplexing and Channel coding”; [REF 3]3GPP TS 36.213 v17.3.0, “E-UTRA, Physical Layer Procedures”; [REF 4]3GPP TS 36.321 v17.3.0, “E-UTRA, Medium Access Control (MAC) protocol specification”; [REF 5]3GPP TS 36.331 v17.3.0, “E-UTRA, Radio Resource Control (RRC) Protocol Specification”; [REF 6]3GPP TR 22.891 v1.2.0; [REF 7]3GPP TS 38.212 v18.0.0, “E-UTRA, NR, Multiplexing and Channel coding”; [REF 8]3GPP TS 38.214 v18.0.0, “E-UTRA, NR, Physical layer procedures for data”; [REF 9]3GPP TS 38.211 v18.0.0, “E-UTRA, NR, Physical channels and modulation”; [REF 10]3GPP TS 38.104 v18.3.0, “E-UTRA, NR, Physical channels and modulation”; [REF 11]O-RAN.WG4.CONF.0-R003-v09.00, “O-RAN Working Group 4 (Fronthaul Working Group) Conformance Test Specification”; and [REF 12]O-RAN.WG4.CUS.0-R003-v13.00, “O-RAN Working Group 4 (Open Fronthaul Interfaces WG)—Control, User and Synchronization Plane Specification”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for early CSI-RS measurement and CSI reporting. In certain embodiments, one or more of the BSs 101-103 include circuitry, programing, or a combination thereof to support early CSI-RS measurement and CSI reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

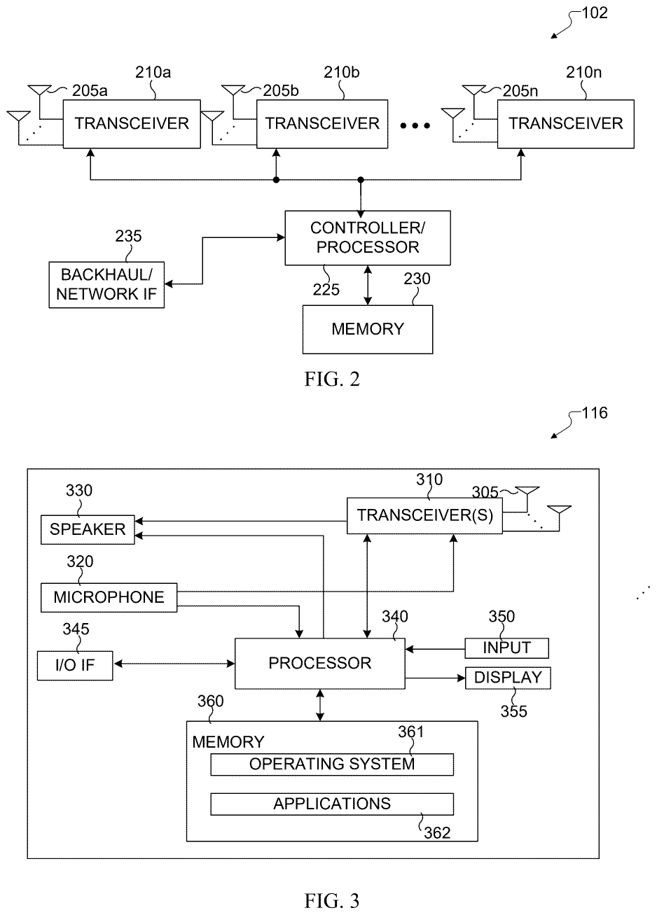

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for early CSI-RS measurement and CSI reporting. Any of a wide variety of other functions could be supported in the gNB 102 by the controller/processor 225.

The controller/processor 225 is also capable of executing programs and other processes resident in the memory 230, such as processes to support early CSI-RS measurement and CSI reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for early CSI-RS measurement and CSI reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

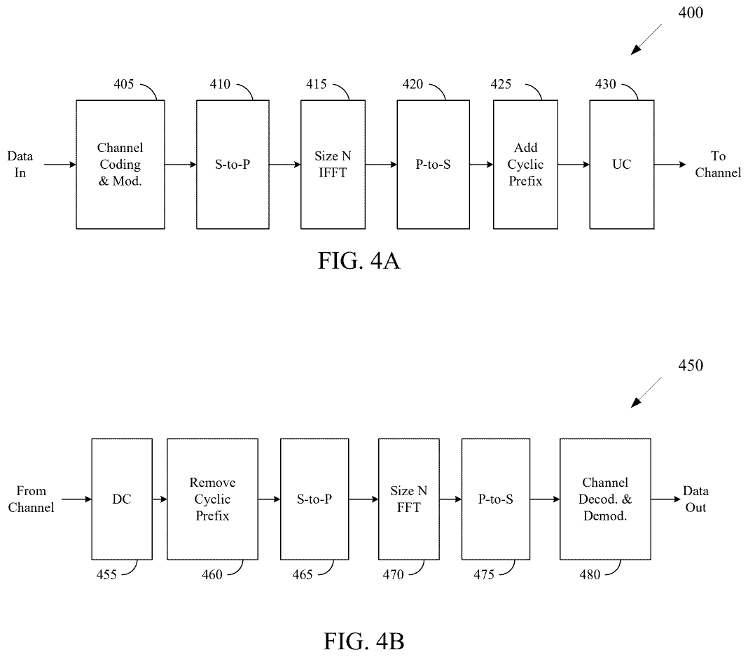

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for early CSI-RS measurement and CSI reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

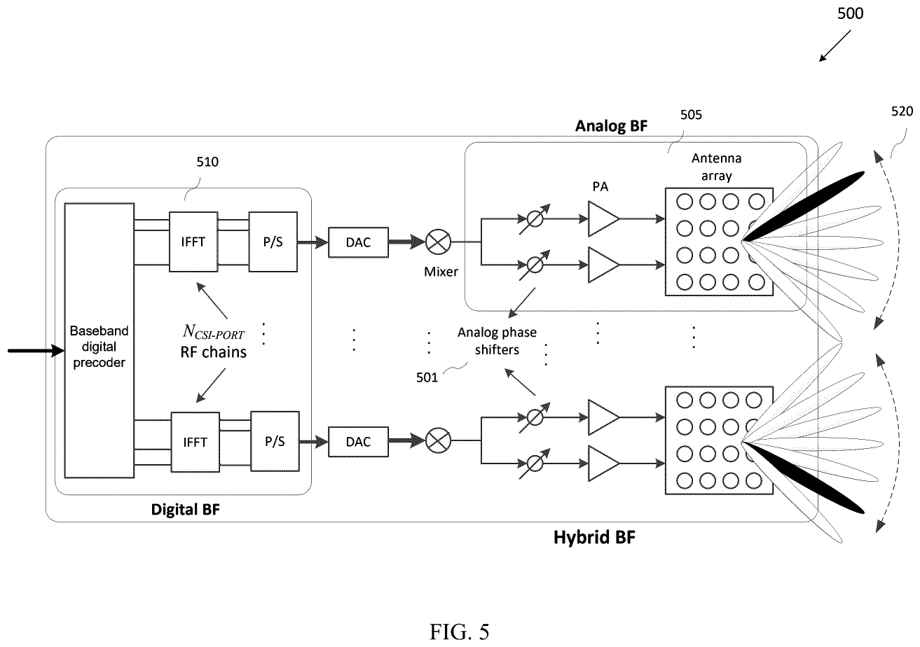

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of CSI-RS ports—which can correspond to the number of digitally precoded ports—can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

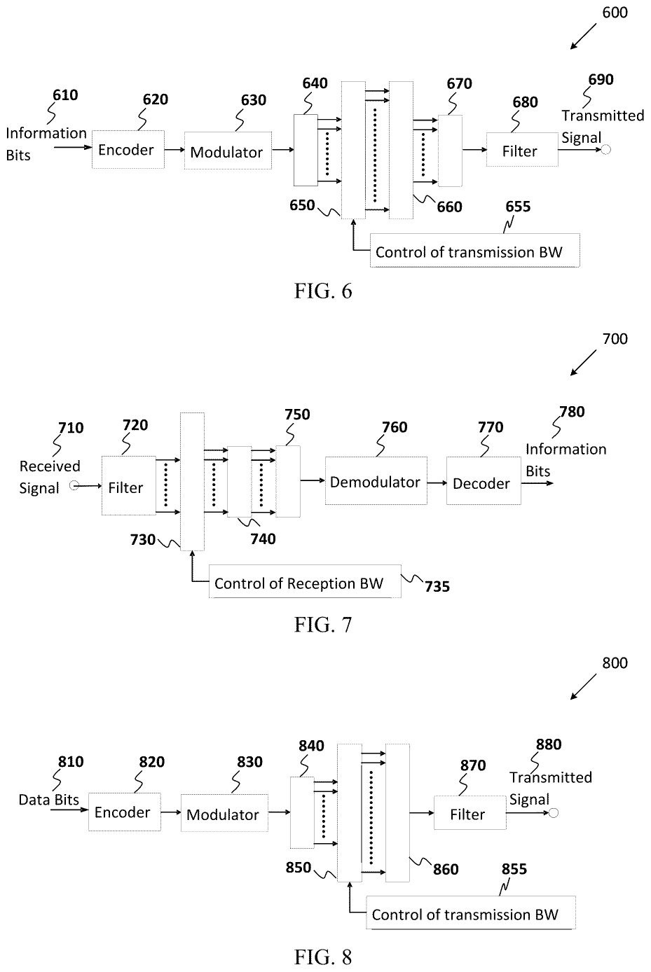

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

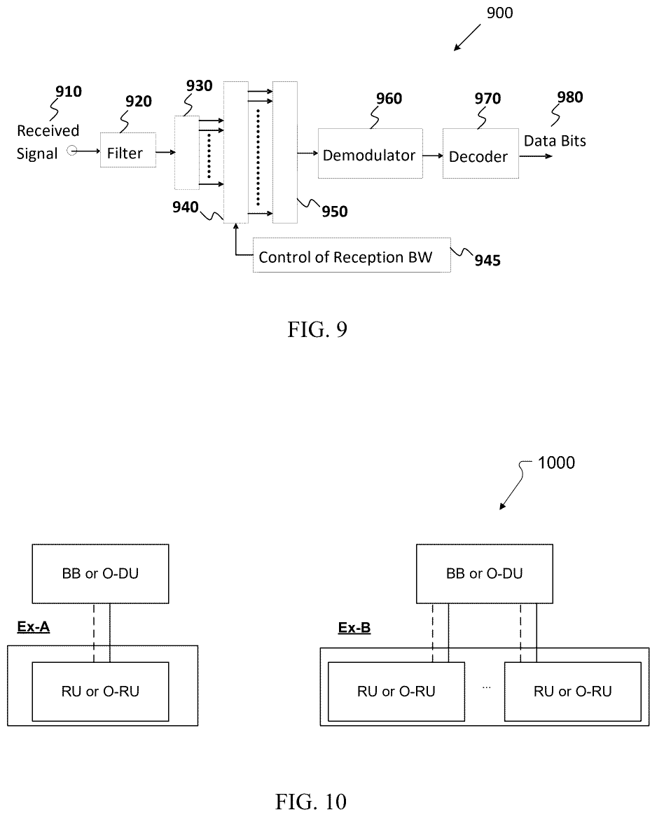

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown in Table 1. Whenever the FR2 is referred, both FR2-1 and FR2-2 frequency sub-ranges shall be provided, unless otherwise stated.

TABLE 1
Definition of frequency ranges

| | |
|---|---|
| Frequency range designation | Corresponding frequency range |

| FR1 | | 410 MHz-7125 MHz |
|---|---|---|
| FR2 | FR2-1 | 24250 MHz-52600 MHz |
| | FR2-2 | 52600 MHz-71000 MHz |

In next generation cellular standards (e.g., 6G), in addition to FR1 and FR2, new carrier frequency bands can be taken into account, e.g., terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs or O-RUs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

Likewise, for a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) or TRP is challenging due to a larger antenna form factor size needed evaluating carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiple user multiple-input-multiple-output (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g., use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

FIG. 10 illustrates a diagram of example RAN configurations 1000 according to embodiments of the present disclosure. For example, RAN configurations 1000 can be implemented by the BS 102 of FIG. 1. This example is for illustration only and other embodiments can be used without departing from the scope of the present disclosure.

Likewise, for O-RAN, a TRP can be functionally equivalent to (hence can be replaced with) or is interchangeable with one of more of the following:
One RU or O-RU: a logical node that includes a subset of the eNB/gNB functions (e.g., as listed in clause 4.2 split option 7-2x)
More than one RUs or O-RUs
One or more than one RUs or O-RUs

Two examples are shown in FIG. 6.

The following are defined in [REF11 and REF12].

| | |
|---|---|
| O-CU | O-RAN Central Unit - a logical node hosting PDCP, RRC, SDAP and other control |
| | functions |
| O-DU | O-RAN Distributed Unit: a logical node hosting RLC/MAC/High-PHY layers based |
| | on a lower layer functional split. O-DU in addition hosts an M-Plane instance. |
| O-RU | O-RAN Radio Unit: a logical node hosting Low-PHY layer and RF processing based |
| | on a lower layer functional split. This is similar to 3GPP's “TRP” or “RRH” but more |
| | specific in including the Low-PHY layer (FFT/iFFT, PRACH extraction). O-RU in |
| | addition hosts M-Plane instance. |

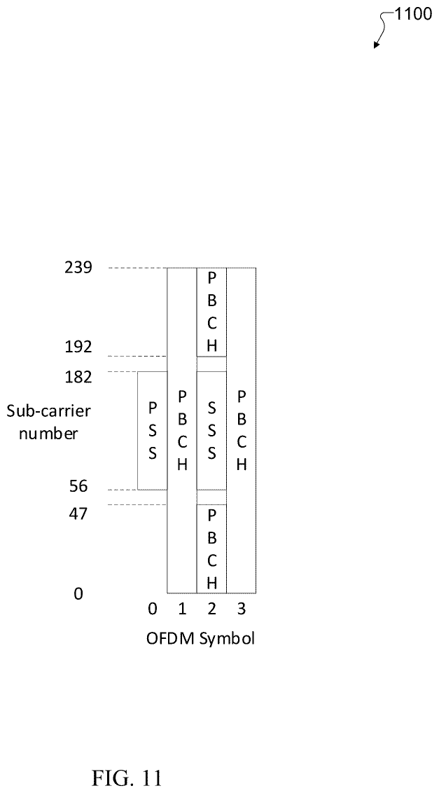

FIG. 11 illustrates an example SSB block 1100 according to embodiments of the present disclosure. The example SSB block 1100 shown in FIG. 11 is for illustration only and other embodiments can be used without departing from the scope of the present disclosure.

In 5G/NR, a geographical area served by the network can be partitioned into cells as aforementioned. For example, a cell can be associated with a synchronization signal, physical broadcast channel (PBCH) block (SS/PBCH block). Within a cell, other common channels and/or signals can be transmitted to users in the cell. In another example, a cell is served by one or more TRPs or by one or more RUs.

In 5G/NR, a UE performs the cell search procedure to acquire time and frequency synchronization within a cell and to detect the physical layer Cell ID (PCI) of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and consists of 4 consecutive symbols, and 20 resource blocks (RBs) (240 subcarriers), as illustrated in FIG. 11.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon or in SSB-MTC-AdditionalPCI or in LTM-SSB-Config.

SSBs are transmitted periodically, wherein the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH consists of a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of RBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one-time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {1/8,1/4,1/2,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon or in SSB-MTC-AdditionalPCI or in LTM-SSB-Config are mapped to valid PRACH occasions in the following order [38.213 v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

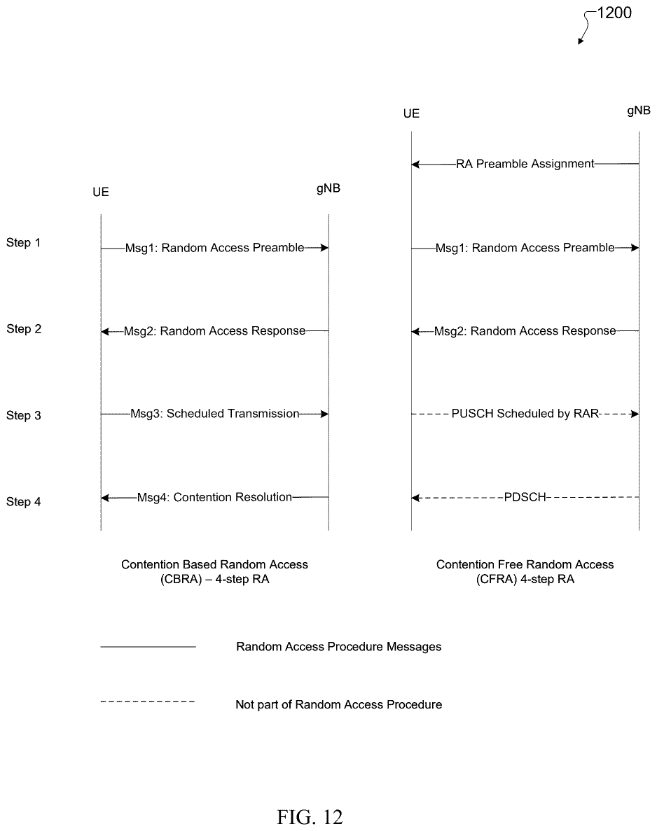

FIG. 12 illustrates an example type-1 random access procedure 1200 according to embodiments of the present disclosure. The example type-1 random access procedure 1200 shown in FIG. 12 is for illustration only and other embodiments can be used without departing from the scope of the present disclosure.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIG. 12;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant included in the RAR and time adjusted according to the TA received in the RAR. Msg3 or the PUSCH scheduled by the RAR UL grant can include the RRC setup request message.
In step 4, the gNB upon receiving the RRC setup request message, allocates downlink and uplink resources that are transmitted in a downlink PDSCH transmission to the UE.

After the last step, the UE can proceed with reception and transmission of data traffic.

A type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

In this disclosure Msg1, preamble and PRACH are used inter-changeably for random access preamble.

In this disclosure Msg2 and RAR are used inter-changeably for random access response.

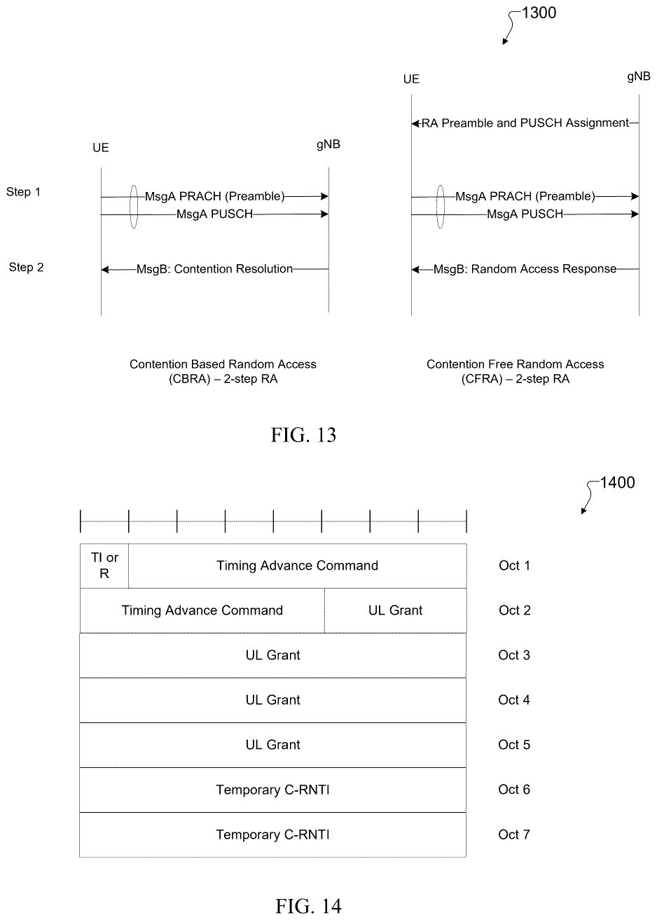

FIG. 13 illustrates an example type-2 random access procedure 1300 according to embodiments of the present disclosure. The example type-2 random access procedure 1300 shown in FIG. 13 is for illustration only and other embodiments can be used without departing from the scope of the present disclosure.

Rel-16, introduced a new random access procedure; Type-2 random access procedure, also known as 2-step random access procedure (2-step RACH), is as illustrated in FIG. 13, that combines the preamble and PUSCH transmission into a single transmission from the UE to the gNB, which is known as MsgA. Similarly, the RAR and the PDSCH transmission (e.g., Msg4) are combined into a single downlink transmission from the gNB to the UE, which is known as MsgB.

A random access procedure can be triggered for initial access from the RRC_IDLE state. During this procedure, a UE identifies an SS/PBCH block with index i and with an RSRP that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

FIG. 14 illustrates an example MAC RAR 1400 (for type-1 random access procedure) according to embodiments of the present disclosure. The example MAC RAR 1400 shown in FIG. 14 is for illustration only and other embodiments can be used without departing from the scope of the present disclosure.

The MAC RAR (for Type 1 random access procedure) includes the 12-bit Timing Advance command as illustrated in FIG. 14 (TS 38.321 FIG. 6.2.3-1), where,
R: Reserved bit, set to 0
TI: If two TAGs are configured for the Serving Cell in which the Random Access procedure is being performed, this field indicates one of the two TAGs to which the Timing Advance Command is applied

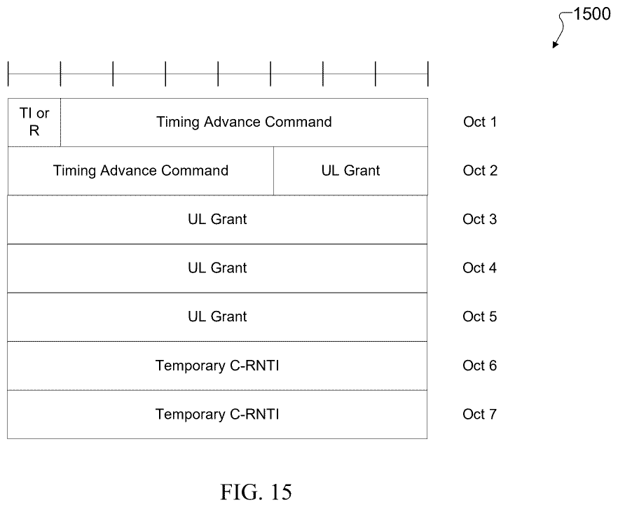

FIG. 15 illustrates an example fallback RAR 1500 (for type-2 random access procedure) according to embodiments of the present disclosure. The example fallback RAR 1500 shown in FIG. 15 is for illustration only and other embodiments can be used without departing from the scope of the present disclosure.

The fallback RAR (for Type 2 random access procedure), which is used when MSGA PRACH is successfully received but MSGA PUSCH is not decoded correctly, includes the 12-bit Timing Advance command as illustrated in FIG. 15 (38.321 FIG. 6.2.3a-1), where,
R: Reserved bit, set to 0
TI: If two TAGs are configured for the SpCell, this field indicates one of the two TAGs to which the Timing Advance Command is applied

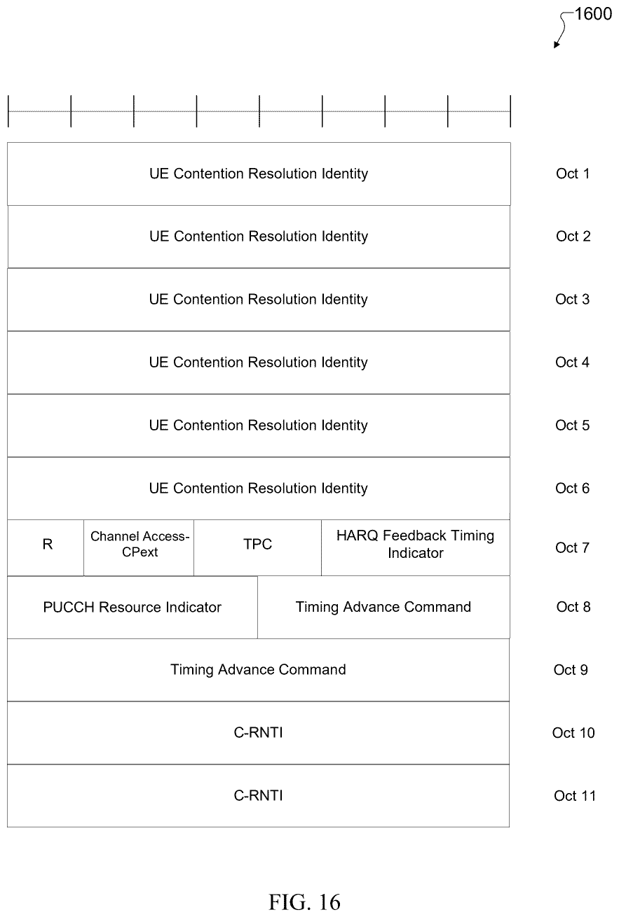

FIG. 16 illustrates an example success RAR 1600 (for type-2 random access procedure) according to embodiments of the present disclosure. The example success RAR 1600 shown in FIG. 16 is for illustration only and other embodiments can be used without departing from the scope of the present disclosure.

The success RAR (for Type 2 random access procedure), which is used when MSGA PRACH is successfully received and MSGA PUSCH is decoded correctly, includes the 12-bit Timing Advance command as illustrated in FIG. 16 (38.321 FIG. 6.2.3a-2).

In one example, the UL grant in the MAC RAR or fallbackRAR is given by Table 2:

TABLE 2

| RAR grant field | Number of bits |
|---|---|
| Frequency hopping flag | 1 |
| PUSCH frequency resource | 12, for operation with shared |
| allocation | spectrum channel access in FR1 |
| | or for FR2-2 when |
| | ChannelAccessMode2-r17 |
| | is provided 14, otherwise |
| PUSCH time resource allocation | 4 |
| MCS | 4 |
| TPC command for PUSCH | 3 |
| CSI request | 1 |
| ChannelAccess-CPext | 2, for operation with shared |
| | spectrum channel access in FR1 |
| | or for FR2-2 when |
| | ChannelAccessMode2-r17 |
| | is provided 0, otherwise |

The CSI reference resource for a serving cell is defined as follows:
In the frequency domain, the CSI reference resource is defined by the group of downlink physical resource blocks corresponding to the band to which the derived CSI relates.
In the time domain, the CSI reference resource for a CSI reporting in uplink slot n′ is defined by a single downlink slot

$$n - {n}_{CSI \_ ref} - {K}_{offset} \cdot \frac{{2}^{{μ}_{DL}}}{{2}^{{μ}_{{K}_{offset}}}} ,$$

where K_{offset} is a parameter configured by higher layer as specified in clause 4.2 of [6 TS 38.213], and where μ_{K}_{_{offset}} is the subcarrier spacing configuration for K_{offset} with a value of 0 for frequency range 1,
   where

$$n = ⌊ {n}^{′} \cdot \frac{{2}^{{μ}_{DL}}}{{2}^{{μ}_{UL}}} ⌋ + ⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \cdot {2}^{{μ}_{DL}} ⌋$$

and μ_{DL} and μ_{DL} are the subcarrier spacing configurations for DL and UL, respectively, and

$${N}_{slot , offset}^{CA}$$

and μ_{offset} are determined by higher-layer configured ca-SlotOffset for the cells transmitting the uplink and downlink, as defined in clause 4.5 of [4, TS 38.211]
where for periodic and semi-persistent CSI reporting
   if a single CSI-RS/SSB resource is configured for channel measurement n_{CSI_ref} is the smallest value greater than or equal to 4-2^{DL}, such that it corresponds to a valid downlink slot, or
   if multiple CSI-RS/SSB resources are configured for channel measurement n_{CSI_ref} is the smallest value greater than or equal to 5-2^{DL}, such that it corresponds to a valid downlink slot.
where for aperiodic CSI reporting, if the UE is indicated by the DCI to report CSI in the same slot as the CSI request, n_{CSI_ref} is such that the reference resource is in the same valid downlink slot as the corresponding CSI request, otherwise n_{CSI_ref} is the smallest value greater than or equal to

$$⌊ {Z}^{′} / {N}_{symb}^{slot} ⌋ ,$$

such that slot n−n_{CSI_ref} corresponds to a valid downlink slot, where Z′ corresponds to the delay requirement as defined in Clause 5.4.
when periodic or semi-persistent CSI-RS/CSI-IM or SSB is used for channel/interference measurements, the UE is not expected to measure channel/interference on the CSI-RS/CSI-IM/SSB whose last OFDM symbol is received up to Z′ symbols before transmission time of the first OFDM symbol of the aperiodic CSI reporting.

A slot in a serving cell shall be considered to be a valid downlink slot if:
it comprises at least one higher layer configured downlink or flexible symbol, and
it does not fall within a configured measurement gap for that UE

If there is no valid downlink slot for the CSI reference resource corresponding to a CSI Report Setting in a serving cell, CSI reporting is omitted for the serving cell in uplink slot n′.

After the CSI report (re)configuration, serving cell activation, BWP change, or activation of SP-CSI, the UE reports a CSI report only after receiving at least one CSI-RS transmission occasion for channel measurement and CSI-RS and/or CSI-IM occasion for interference measurement no later than CSI reference resource and drops the report otherwise.

When DRX is configured, the UE reports a CSI report only if receiving at least one CSI-RS transmission occasion for channel measurement and CSI-RS and/or CSI-IM occasion for interference measurement in DRX Active Time no later than CSI reference resource and drops the report otherwise. When DRX is configured and the CSI-RS Resource Set for channel measurement corresponding to a CSI report is configured with two Resource Groups and N Resource Pairs, as described in clause 5.2.1.4.1, the UE reports a CSI report only if receiving at least one CSI-RS transmission occasion for each CSI-RS resource in a Resource Pair within the same DRX Active Time no later than CSI reference resource and drops the report otherwise. When the UE is configured to monitor DCI format 2_6 and if the UE configured by higher layer parameter ps-TransmitOtherPeriodicCSI to report CSI with the higher layer parameter reportConfigType set to ‘periodic’ and reportQuantity set to quantities other than ‘cri-RSRP’, ‘ssb-Index-RSRP’, ‘cri-RSRP-Capability[Set]Index’, and ‘ssb-Index-RSRP-Capability[Set]Index’ when drx-onDurationTimer is not started, the UE shall report CSI during the time duration indicated by drx-onDurationTimer in DRX-Config also outside active time according to the procedure described in Clause 5.2.1.4 if receiving at least one CSI-RS transmission occasion for channel measurement and CSI-RS and/or CSI-IM occasion for interference measurement during the time duration indicated by drx-onDurationTimer in DRX-Config outside DRX active time or in DRX Active Time_no later than CSI reference resource and drops the report otherwise. When the UE is configured to monitor DCI format 2_6 and if the UE configured by higher layer parameter ps-TransmitPeriodicL1-RSRP to report L1-RSRP with the higher layer parameter reportConfigType set to ‘periodic’ and reportQuantity set to ‘cri-RSRP’, ‘ssb-Index-RSRP’, ‘cri-RSRP-Capability[Set]Index’, or ‘ssb-Index-RSRP-Capability[Set]Index’ when drx-onDurationTimer is not started, the UE shall report L1-RSRP during the time duration indicated by drx-onDurationTimer in DRX-Config also outside active time according to the procedure described in clause 5.2.1.4 and when reportQuantity set to ‘cri-RSRP’ or ‘cri-RSRP-Capability[Set]Index’ if receiving at least one CSI-RS transmission occasion for channel measurement during the time duration indicated by drx-onDurationTimer in DRX-Config outside DRX active time or in DRX Active Time no later than CSI reference resource and drops the report otherwise.

When deriving CSI feedback, the UE is not expected that a NZP CSI-RS resource for channel measurement overlaps with CSI-IM resource for interference measurement or NZP CSI-RS resource for interference measurement.

If configured to report CQI index, in the CSI reference resource, the UE shall assume the following for the purpose of deriving the CQI index, and if also configured, for deriving PMI and RI:
The first 2 OFDM symbols are occupied by control signaling.
The number of PDSCH and DM-RS symbols is equal to 12.
The same bandwidth part subcarrier spacing configured as for the PDSCH reception
The bandwidth as configured for the corresponding CQI report.
The reference resource uses the CP length and subcarrier spacing configured for PDSCH reception
No resource elements used by primary or secondary synchronization signals or PBCH.
Redundancy Version 0.
The ratio of PDSCH EPRE to CSI-RS EPRE is as given in Clause 5.2.2.3.1.
Assume no REs allocated for NZP CSI-RS and ZP CSI-RS.
Assume the same number of front-loaded DM-RS symbols as the maximum front-loaded symbols configured by the higher layer parameter maxLength in DMRS-DownlinkConfig.
Assume the same number of additional DM-RS symbols as the additional symbols configured by the higher layer parameter dmrs-AdditionalPosition.
Assume the PDSCH symbols are not containing DM-RS.
Assume PRB bundling size of 2 PRBs.
The PDSCH transmission scheme where the UE may assume that PDSCH transmission would be performed with up to 8 transmission layers as defined in Clause 7.3.1.4 of [4, TS 38.211]. For CQI calculation, the UE should assume that PDSCH signals on antenna ports in the set [1000, . . . , 1000+v−1] for v layers would result in signals equivalent to corresponding symbols transmitted on antenna ports [3000, . . . , 3000+P−1], as given by

$$[ \begin{matrix}{y}^{( 3000 )} ( i ) \\ ⋯ \\ {y}^{( 3000 + P - 1 )} ( i )\end{matrix} ] = W ( i ) [ \begin{matrix}{x}^{( 0 )} ( i ) \\ ⋯ \\ {x}^{( v - 1 )} ( i )\end{matrix} ]$$

where x(i)=[x⁽⁰⁾(i) . . . x^{(v-1)}(i)]^{T} is a vector of PDSCH symbols from the layer mapping defined in Clause 7.3.1.4 of [4, TS 38.211], Pϵ[1,2,4,8,12,16,24,32] is the number of CSI-RS ports. If only one CSI-RS port is configured, W(i) is 1. If the higher layer parameter reportQuantity in CSI-ReportConfig for which the CQI is reported is set to either ‘cri-RI-PMI-CQI’ or ‘cri-RI-LI-PMI-CQI’, W(i) is the precoding matrix corresponding to the reported PMI applicable to x(i). If the higher layer parameter reportQuantity in CSI-ReportConfig for which the CQI is reported is set to ‘cri-RI-CQI’, W(i) is the precoding matrix corresponding to the procedure described in Clause 5.2.1.4.2. If the higher layer parameter reportQuantity in CSI-ReportConfig for which the CQI is reported is set to ‘cri-RI-i1-CQI’, W(i) is the precoding matrix corresponding to the reported i1 according to the procedure described in Clause 5.2.1.4.2. The corresponding PDSCH signals transmitted on antenna ports [3000, . . . , 3000+P−1] would have a ratio of EPRE to CSI-RS EPRE equal to the ratio given in Clause 5.2.2.3.1. If the higher layer parameter reportQuantity in CSI-ReportConfig for which the CQI is reported is set to either ‘cri-RI-PMI-CQI’ or ‘cri-RI-LI-PMI-CQI’, the corresponding CSI-RS Resource Set for channel measurement is configured with two Resource Groups and N Resource Pairs, as described in clause 5.2.1.4.1, the reported CRI corresponds to an entry of the N Resource Pairs, and the reported rank combination is {v₁, v₂}, as described in clause 5.2.1.4.2, for CQI calculation, the UE should assume that
PDSCH signals on antenna ports in the set [1000, . . . , 1000+v₁−1] for v₁ layers would result in signals equivalent to corresponding symbols transmitted on antenna ports [3000, . . . , 3000+P−1] of the Group 1 CSI-RS resource in the Resource Pair indicated by the CRI, and PDSCH signals on antenna ports in the set [1000+v₁, . . . , 1000+v₁+v₂−1] for v₂ layers would result in signals equivalent to corresponding symbols transmitted on antenna ports [3000, . . . , 3000+P−1] of the Group 2 CSI-RS resource in the Resource Pair indicated by the CRI, as given by

$$[ \begin{matrix}\begin{matrix}{y}_{j}^{( 3000 )} ( i ) \\ ⋯\end{matrix} \\ {y}_{j}^{( 3000 + P - 1 )} ( i )\end{matrix} ] = {W}_{j} ( i ) [ \begin{matrix}\begin{matrix}{x}^{( ( j - 1 ) \cdot {v}_{1} )} ( i ) \\ ⋯\end{matrix} \\ {x}^{( {v}_{1} + ( j - 1 ) \cdot {v}_{2} - 1 )} ( i )\end{matrix} ]$$

where Wⱼ(i), j=1,2 are the two precoding matrices corresponding to the two reported PMIs applicable to x(i), as described in clause 5.2.1.4.2; and the indices j=1,2 are associated to the two Resource Groups configured in the corresponding CSI-RS Resource Set for channel measurement; that the signals yⱼ, j=1,2, fully overlap in time and frequency, and that, for the calculation of RI, PMI and LI (if configured) of vⱼ layers, j=1,2, the interference from the other v_{(j mod 2)+1} layers is derived from channel measurement and precoding matrix corresponding to the other v_{(j mod 2)+1} layers.
The UE shall assume that the corresponding PDSCH signals for v₁ layers transmitted on the P antenna ports of the CSI-RS resource in Group j would have a ratio of EPRE to CSI-RS EPRE equal to the powerControlOffset of the respective CSI-RS resource, for j=1,2.

Embodiments of the present disclosure recognize that when a UE is in RRC_IDLE state or RRC_INACTIVE state, and data arrives at the network for the UE, or data arrives at the UE for the network, the UE through RRC setup procedure or RRC reconfiguration procedure transitions to the RRC_CONNECTED state. After transition to the RRC_CONNECTED state the network can trigger CSI-RS transmission for the UE to calculate CSI report so that the UE can start transmitting and receiving data. The CSI-RS/CSI triggered can be wideband or sub-band. This process of measurement and reporting can take tens of milli-seconds. Data transmission/reception can be delayed until the CSI has been acquired at the NW, hence increasing latency to serve the UE. Alternatively, data transmission/reception can proceed in parallel with CSI-RS measurement and CSI reporting and by the time the channel quality is estimated, the data (depending on the amount of data) has already or mostly been transmitted or received, hence rendering the CSI acquisition less useful while preceding transmissions/receptions from/to the UE are with reduced spectral efficiency due to the absence of a channel estimate at the gNB for the UE.

To mitigate this issue, it is beneficial to have the CSI acquisition in parallel with the RRC setup procedure, or RRC reconfiguration procedure such that when the UE is ready to transmit or receive data at the completion of the setup or reconfiguration procedures, the channel quality has already been estimated and link adaptation and precoding for uplink or downlink data is based on the acquired CSI. Hence, there is a benefit with CSI-RS measurement and CSI reporting in parallel with RRC setup procedure, or RRC reconfiguration procedure to reduce latency.

When the network initiates a communication session, the UE is first paged, and this is then followed by a random access (RA), or also referred to as RACH procedure. When the UE initiates a communication session, a RACH procedure is used. This disclosure also provides signaling and methods for CSI-RS measurement and CSI reporting during a RACH procedure, or associated with a RACH procedure. In one example, CSI-RS/CSI can be triggered using a message separate from the RACH procedure messages. In another example, CSI-RS/CSI can be triggered using a RACH procedure message, e.g., CSI-RS/CSI can be triggered within RACH msg2 (RAR), or RACH msg4 for type-1 random access procedure, or RACH msgB for type-2 random access procedure. In one example, CSI-RS/CSI can be triggered using a DCI or MAC CE, after the RACH procedure messages. CSI-RS/CSI transmission/reception can be separate from the RACH procedure messages, or can be transmitted in conjunction with the RACH procedure messages. In one example, the UE capability to support early CSI-RS/CSI can be indicated to the network in the RACH procedure messages (e.g., in Msg1, Msg3, or MsgA (in the PRACH part of MsgA and/or PUSCH part of MsgA). In one example, a UE context is stored in the network (e.g., when the UE is in the RRC_INACTIVE state), the UE context contains the UE capability to support early CSI-RS/CSI, when the network associates the UE triggering the random access procedure with the UE context, the network can determine the UE capability. The network can trigger the early CSI-RS/CSI in the RA procedure, e.g., Msg2 or Msg4 or MsgB, or in a DCI Format transmitted after the RA procedure. The early CSI-RS/CSI trigger can indicate the timing of the CSI-RS/CSI transmission/reception.

Accordingly, the present disclosure provides early CMR/IMR measurement and CSI reporting to facilitate fast UL/DL data transmission for a UE getting RRC connected from RRC-IDLE or INACTIVE state.

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

The present disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In the present disclosure MAC CE signaling can be UE-specific e.g., to one UE or can be UE common (e.g., to a group of UEs or to all UEs in a cell). MAC CE signaling can be DL MAC CE signaling or UL MAC CE signaling.

In the present disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE and can be UE common (e.g., to a group of UEs or to all UEs in a cell).

In the present disclosure, configuration can refer to configuration by semi-static signaling (e.g., RRC or SIB signaling). In one example, a configuration can be applicable to multiple transmission instances, until a configuration is received and applied.

In the present disclosure, DCI Format is used for L1 control information in the DL direction from gNB to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g., for a second part).

In the present disclosure, a higher layer message (e.g., SIB-based or RRC-based or MAC CE-based) can be carried by a physical downlink shared channel (PDSCH). In one example, the PDSCH can be scheduled by a DCI format.

In the present disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In the present disclosure a list with N elements can be denoted as L(i), where i can take N values, and L(i) can correspond to the element associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In the present disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In the present disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

In the present disclosure Msg5 refers to the message transmitted by the UE in response to Msg4. For example Msg5 can be connection setup complete or resume complete.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting bands with Mₙ subbands when one CSI parameter is reported for each of the Mₙ subbands within the CSI reporting band.

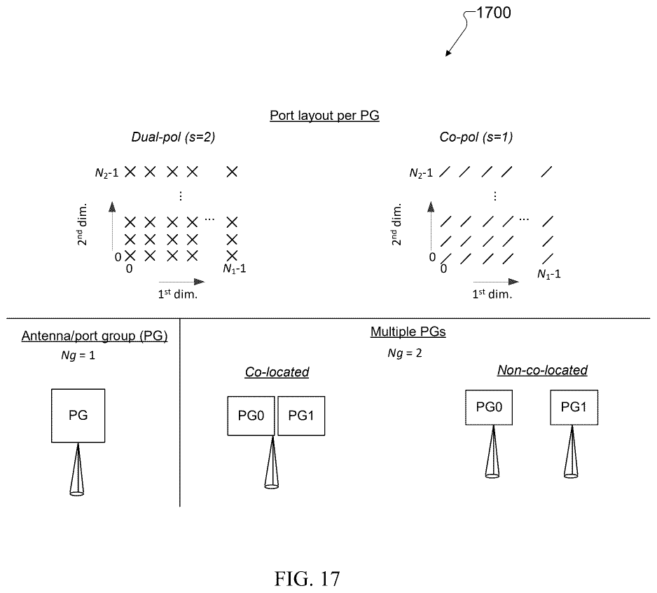

FIG. 17 illustrates an example antenna port layout 1700 according to embodiments of the present disclosure. For example, antenna port layout 1700 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts either have N₁>1 and N₂=1 or N₂>1 and N₁=1. In the rest of the disclosure, 1D antenna port layouts with N₁>1 and N₂=1 is taken into account. The disclosure, however, is applicable to the other 1D port layouts with N₂>1 and N₁=1. Also, in the rest of the disclosure, N₁>N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 17 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=s₁N₂.

Let N_{g} be a number of antenna/port groups (PGs). When there are multiple antenna/port groups (N_{g}>1), each group (gϵ{1, . . . , N_{g}}) comprises N_{1,g} and N_{2,g} ports in two dimensions. This is illustrated in FIG. 17. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g}(for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g., comprising a CSI-RS resource set).

In one example, an antenna/port group corresponds to a reconfigurable intelligent surface (RIS) in which the antenna/port group can be (re-)configured more dynamically (e.g., via MAC CE and/or downlink control information (DCI)). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 10. The antenna structure at each PG or O-RU (or RU) can be the same. Or the antenna structure at an PG or O-RU (or RU) can be different from another PG or O-RU (or RU). Likewise, the number of ports at each PG (OR O-RU OR RU) can be the same. Or the number of ports at one PG (OR O-RU OR RU) can be different from another PG (OR O-RU OR RU).

In another example, the antenna architecture of the MIMO system is unstructured. For example, the antenna structure at one PG (OR O-RU OR RU) can be different from another PG (OR O-RU OR RU).

A structured antenna architecture is provided in the rest of the disclosure. For simplicity, each PG (OR O-RU OR RU) is equivalent to a panel (cf. FIG. 17), although, an PG (OR O-RU OR RU) can have multiple panels in practice. The disclosure however is not restrictive to a single panel expectation at each PG (OR O-RU OR RU), and can easily be extended (covers) the case when an PG (OR O-RU OR RU) has multiple antenna panels.

In one embodiment, an PG (or O-RU OR RU) constitutes (or corresponds to or is equivalent to) at least one of the following:
In one example, an PG OR O-RU (OR RU) corresponds to a TRP.
In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g., an RRC parameter). Or it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CQI report interval (CRI) or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

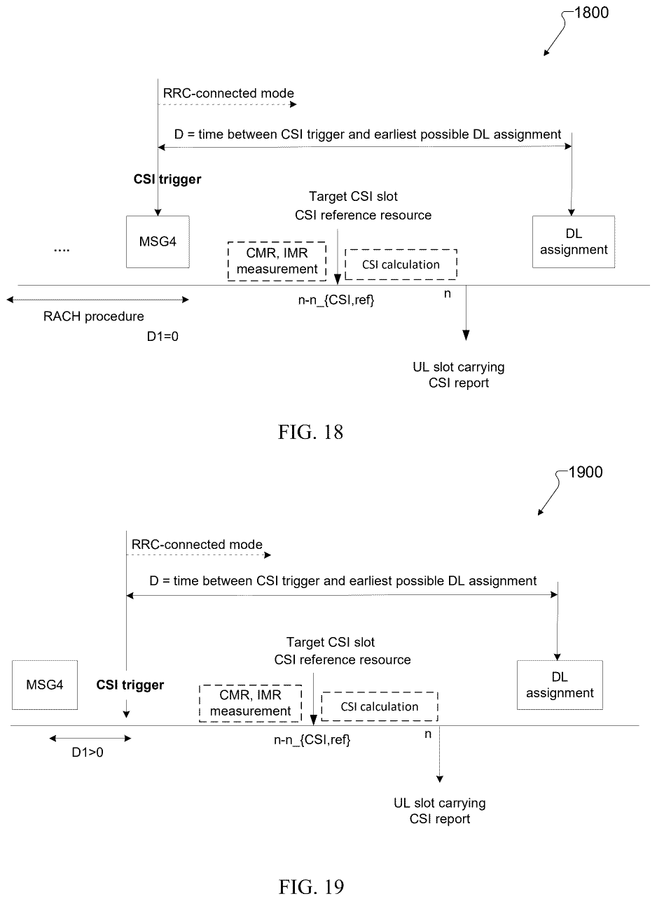

FIG. 18 illustrates an example of configuring a UE with a CSI report 1800 according to embodiments of the present disclosure. For example, the UE 116 of FIG. 3 can be configured to use the CSI report. This example is for illustration only and other embodiments can be used without departing from the scope of the present disclosure.

FIG. 19 illustrates another example of configuring a UE with a CSI report 1900 according to embodiments of the present disclosure. For example, the UE 116 of FIG. 3 can be configured to use the CSI report. This example is for illustration only and other embodiments can be used without departing from the scope of the present disclosure.

In one embodiment, a UE is configured (e.g., via a higher layer CSI configuration information) with a CSI report, where the CSI report is based on a channel measurement (and/or interference measurement). The CSI report can be based on a codebook, e.g., when PMI is included in the CSI report. When the CSI report is configured to be aperiodic, it is reported when triggered via a DCI field (e.g., a CSI request field) in a DCI.

In one example, as shown in FIG. 18, the CSI report is triggered via a trigger message associated with or included in Msg4 of a RACH procedure (when the UE undergoes a RACH procedure to get RRC-connected from RRC-IDLE or RRC-INACTIVE mode). In this example, there is no time additional time duration, i.e., D₁=0, between the last step of the RACH procedure (i.e., Msg4) and the first step of the CSI reporting procedure (i.e., CSI trigger). Alternatively, as shown in FIG. 19, the UE receives a CSI trigger message in D₁>0 slots after the Msg4 slot. The trigger can be included in a DCI format (e.g., either a DL-DCI format that schedules a DL transmission, or a dedicated DL-DCI, or am UL-DCI includes a CSI request). The value of D₁ can be fixed (i.e., the min time necessary for the UE to receive a trigger after getting RRC-connected). In one example, the value of D₁ is provided via a parameter in Msg4. In one example, the value of D₁ is provided in an earlier slot, e.g., SIB or Msg2. In one example, a set of candidate values for D₁ is included in SIB or Msg2, and one value from the set of values is provided via Msg4.

As shown, the CSI reporting procedure starts as soon as the UE receives the CSI trigger message. The CSI report can be based on (or linked to) a measurement procedure in which the UE measures channel and/or interference (CMR and/or IMR), and use the measurement to determine the CSI report. For a CSI reported in a slot n, a CSI reference resource is defined by (a) a set of PRBs, and (b) a slot n−n_{CSI,ref} that is n_{CSI,ref} earlier than the CSI reporting slot. The details about the CSI reference slot is described later in this disclosure. The CSI reference resource slot is the latest slot in which the CMR/IMR can be measured by the UE. In general, the UE can measure CMR/IMR in at least one slot that can be earlier than or up to the CSI reference resource slot. The UE calculates the CSI report between the CSI reference resource slot n−n_{CSI,ref} and the CSI reporting slot n. The calculated CSI report is transmitted by the UE in slot n. In one example, the slot n is earlier than the slot with the earliest possible DL reception (e.g., 10-13 ms) after the Msg4 (or after setting up the RRC connection).

In one example, the CSI report includes a PMI, (e.g., when reportQuantity set to ‘cri-RI-PMI-CQI’ or ‘cri-LI-RI-PMI-CQI’) where the PMI indicates at least one precoding matrix.
In one example, the reported PMI indicates a precoder matrix associated with a slot.
In one example, the reported PMI indicates precoder matrices associated with N₄ consecutive slots or slot intervals. Each slot interval comprises a duration of d slots. In one example, the value of N₄ϵT, e.g., {1,2,4,8}. In one example, the value of N₄ is fixed (e.g., 1). In one example, the value of N₄ is configured by higher layer parameter (e.g., via SIB1 or RRC or Msg2 or Msg4). The value N₄=1 can be mandatory, and a value N₄>1 can be optional (requires separate UE capability reporting).
In one example, when the UE supports UE-side CSI prediction, the reported PMI indicates a predicted precoder matrix associated with a slot or predicted precoder matrices associated with N₄ consecutive slots or slot intervals. Each slot interval comprises a duration of d slots. In one example, the value of N₄ϵT, e.g., {1,2,4,8}. In one example, the value of N₄ is fixed (e.g., 1). In one example, the value of N₄ is configured by higher layer parameter (e.g., via SIB1 or RRC or Msg2 or Msg4). The value N₄=1 can be mandatory, and a value N₄>1 can be optional (requires separate UE capability reporting).

In one example, for CMRs, the UE is configured with an aperiodic CSI-RS(s) (or resource set) for channel measurement, and the value, in number of slots, of the time unit dϵ{1, m} is configured by higher layer parameter d. In one example, m is fixed (e.g., 1 or 2). In one example, m is configured (e.g., from {1,2}). In one example, for CMR, the UE is configured with a periodic or semi-persistent CSI-RS resource set for channel measurement, and the value of d is equal to the periodicity of the CSI-RS resource.

In one example, for CMRs, the UE if configured with KϵY aperiodic CSI-RS resources or with a single periodic or semi-persistent CSI-RS resource in the resource set for channel measurement. In one example, Y={4,8,12}. For an aperiodic CSI-RS resource set for channel measurement, the K CSI-RS resources are triggered by the same triggering instance and the separation between two consecutive CSI-RS resources is mϵZ slots. In one example, Z={1,2}. In one example, the K CMRs are via higher layer parameter in the NZP-CSI-RS-ResourceSet. In one example, the K aperiodic CSI-RS resources are transmitted following the order of the CSI-RS resource IDs configured in the CSI-RS resource set. In one example, the UE shall assume that the antenna port with the same port index of the K aperiodic CSI-RS resources is the same.

In one example, if interference measurement is performed on CSI-IM, only one resource is configured in the corresponding csi-IM-ResourceSet. Likewise, if interference measurement is performed on NZP CSI-RS, only one resource is configured in the corresponding NZP-CSI-RS-ResourceSet for interference measurement. In one example, the number of IMRs is equal to number of CMRs. In one example, the number of IMR is fixed (e.g., 1) regardless of the number of CMRs.

In one example, the earliest of the N₄ slots or slot intervals starts at slot l=n+δ, where n is the uplink slot in which the CSI is reported and the slot offset δϵX is fixed or configured by higher layer parameter delta, where n_{CSI_ref} is defined earlier/later in this disclosure. In one example, X={−n_{CSI_ref}, 0,1,2}. In one example, X={−n_{CSI_ref}} for early CSI. In one example, X={−n_{CSI_ref},0} for early CSI.

For N₄=1, the UE is expected to report a PMI or predicted PMI for slot l or slot interval [l, l+d−1]. The reported CQI is associated with slot l and the reported PMI.

For N₄>1, the UE is expected to report a PMI or predicted PMI which indicates (predicted) precoder matrices associated with slot intervals [l+j·d, l+(j+1)·d−1], for j=0, . . . , N₄−1. The reported CQI is associated with a slot or multiple slots that is a subset of all slots comprising slot intervals.

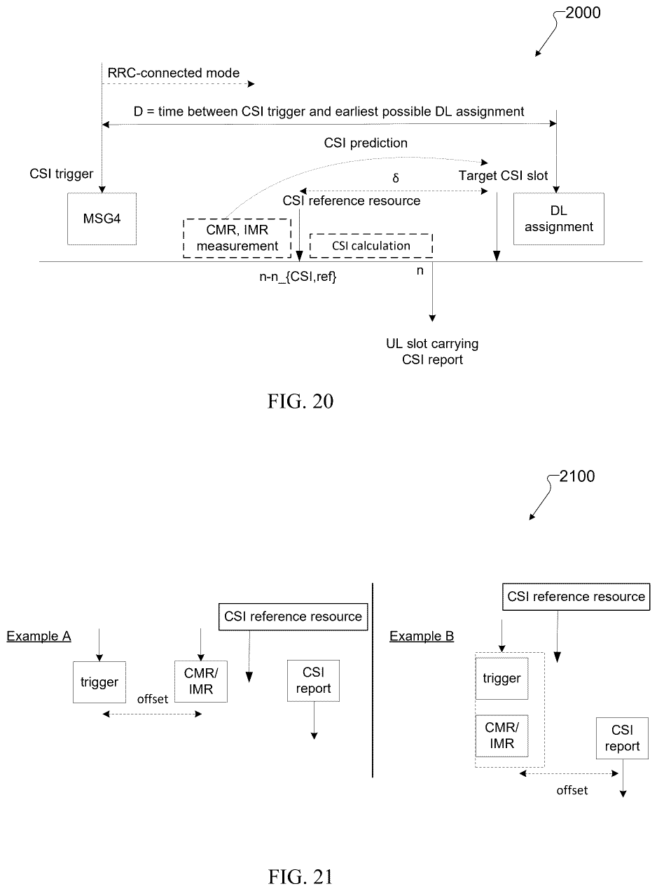

FIG. 20 illustrates an example of UE-sided CSI prediction 2000 according to embodiments of the present disclosure. For example, the UE 116 of FIG. 3 can be configured to use the UE-sided CSI prediction 2000. This example is for illustration only and other embodiments can be used without departing from the scope of the present disclosure.

An illustration of the UE-sided CSI prediction is shown in FIG. 20, wherein a target CSI slot is defined as a slot in which the reported CSI is expected to be valid for. As shown, the target CSI slot is δ slots after the CSI reference resource slot, the UE is expected to perform prediction of channel/interference measurements that happen up to CSI reference resource slot. In one example, when there is no CSI prediction (or the UE does not support prediction), δ=0 and CSI reference resource slot and the target CSI slot are the same. In one example, when there is CSI prediction, δ>0, the two slots are different, and the UE is expected to perform measurement/CSI prediction in the target CSI slot, based on the CMR/IMR measurements up to CSI reference resource slot.

FIG. 21 illustrates an example of using a joint CSI trigger for both CMR/IMR measurement and CSI reporting 2100 according to embodiments of the present disclosure. For example, the UE 116 of FIG. 3 can be configured to use the joint CSI trigger for both CMR/IMR measurement and CSI reporting 2100. This example is for illustration only and other embodiments can be used without departing from the scope of the present disclosure.

In one example, there is one (joint) CSI trigger for both CMR/IMR measurement and CSI reporting. As explained, this trigger can be together with (multiplexed with) Msg4 or MsgB slot, or in a slot after Msg4/MsgB slot. In either case, two examples are possible.
In one example, the UE receives the CMR/IMR in the same slot as the CSI trigger. This is illustrated as Example B in FIG. 21. This corresponds to offset=0.
In one example, the UE receives the CMR/IMR in a slot that is after the CSI triggering slot. This corresponds to offset>0. The offset (e.g., in number of slots) between the slot with the CSI trigger and the slot with the CMR/IMR can be fixed (e.g., 1 or 2 or 4 slots) or configured via higher layer or SIB, or indicated together with the CSI trigger. This offset can be subject to the UE capability. Also, this offset can be dependent on the subcarrier spacing (SCS) and/or the carrier frequency. For instance, the offset is scaled by

$$\frac{{2}^{{μ}_{1}}}{{2}^{{μ}_{2}}}$$

where μ₂ is a reference SCS (e.g., μ₁=0 corresponding to 15 kHz), and μ₁ is the SCS associated with the CSI trigger or the CMR/IMR slot. This is illustrated as Example A in FIG. 21.

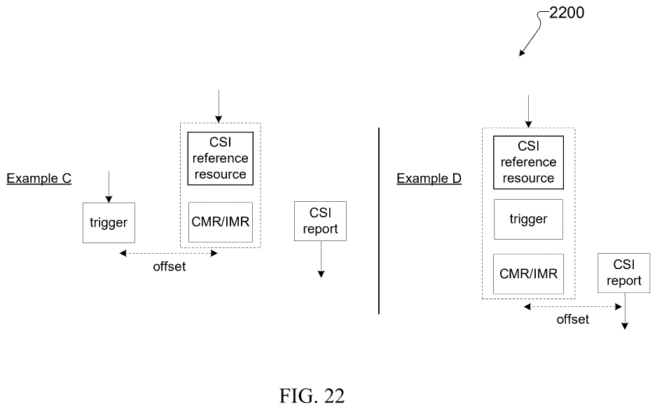

FIG. 22 illustrates an example where the CMR/IMR slot is the same as the CSI reference resource slot for CMR/IMR measurement and CSI reporting 2200 according to embodiments of the present disclosure. For example, the UE 116 of FIG. 3 can be configured to use the same CMR/IMR slot as the CSI reference slot for CMR/IMR measurement and CSI reporting 2200. This example is for illustration only and other embodiments can be used without departing from the scope of the present disclosure.

In one example, the CMR/IMR slot is the same as the CSI reference resource slot, i.e., the CSI reference slot and the CMR/IMR slot can be merged into one. As explained, this trigger can be together with (multiplexed with) Msg4 or MsgB slot, or in a slot after Msg4/MsgB slot. In either case, two examples are possible.

In one example, the UE receives the CMR/IMR in the same slot as the CSI trigger. This is illustrated as Example D in FIG. 22. This corresponds to offset=0.

In one example, the UE receives the CMR/IMR in a slot that is after the CSI triggering slot. This corresponds to offset>0. The offset (e.g., in number of slots) between the slot with the CSI trigger and the slot with the CMR/IMR can be fixed (e.g., 1 or 2 or 4 slots) or configured via higher layer or SIB, or indicated together with the CSI trigger. This offset can be subject to the UE capability. Also, this offset can be dependent on the subcarrier spacing (SCS) and/or the carrier frequency. For instance, the offset is scaled by

$$\frac{{2}^{{μ}_{1}}}{{2}^{{μ}_{2}}}$$

where μ₂ is a reference SCS (e.g., φ₁=0 corresponding to 15 kHz), and μ₁ is the SCS associated with the CSI trigger or the CMR/IMR slot. This is illustrated as Example C in FIG. 22.

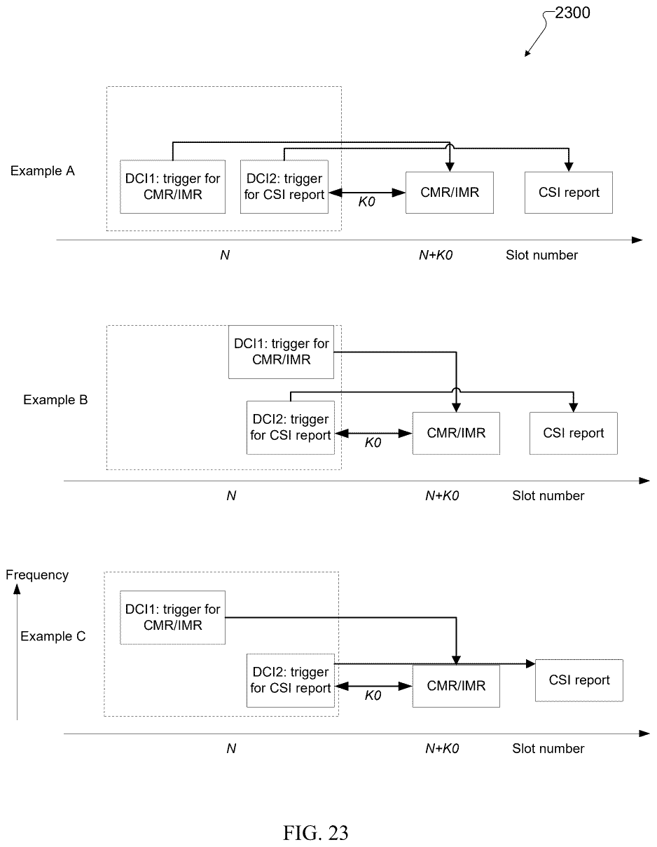

FIG. 23 illustrates examples where separate triggers (DCIs) are received in the same slot and used for the CMR/IMR measurement and the CSI reporting 2300 according to embodiments of the present disclosure. For example, the UE 116 of FIG. 3 can be configured to receive separate triggers (DCIs) the in the same slot and used for the CMR/IMR measurement and the CSI reporting 2300. This example is for illustration only and other embodiments can be used without departing from the scope of the present disclosure.

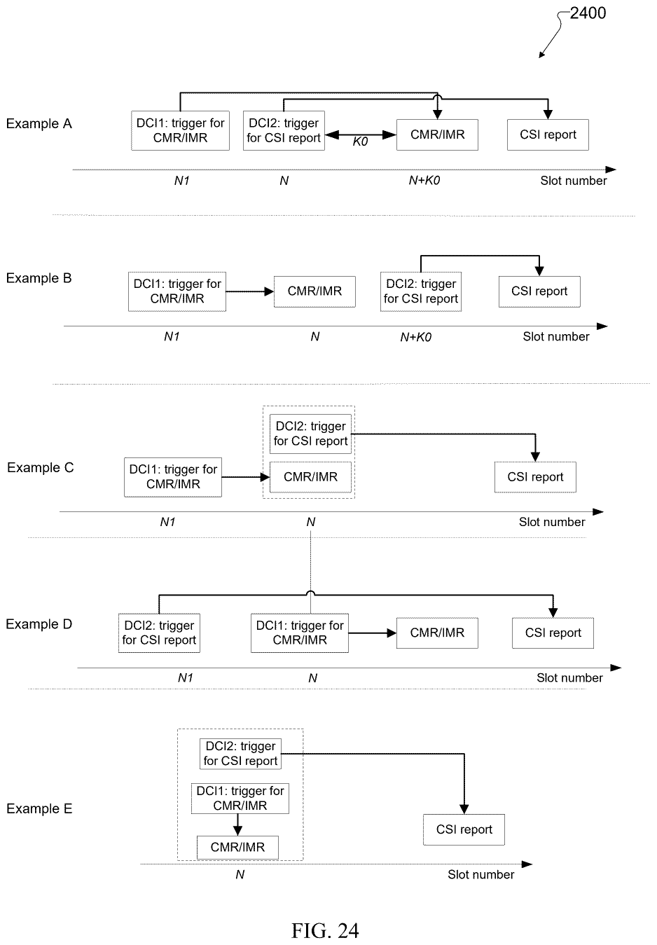

FIG. 24 illustrates examples where separate triggers (DCIs) are received in two different slots and used for the CMR/IMR measurement and the CSI reporting 2400 according to embodiments of the present disclosure. For example, the UE 116 of FIG. 3 can be configured to receive separate triggers (DCIs) the in two different slots and used for the CMR/IMR measurement and the CSI reporting 2400. This example is for illustration only and other embodiments can be used without departing from the scope of the present disclosure.

In one example, there is two separate (independent) triggers, one CMR/IMR measurement and another for CSI reporting. The triggers can be via two DCI formats. The DCI format for CMR/IMR measurement can be a DL-DCI (with or without DL assignment), or a UL-DCI (with or without UL grant), or a dedicated DCI for this purpose. The DCI format for CSI reporting can be a DL-DCI (with or without DL assignment), or a UL-DCI (with or without UL grant), or a dedicated DCI for this purpose. In one example, the two DCI formats have to be of the same type or format (either DL-DCI or UL-DCI or dedicated DCI), although the UE receives them independently (in the same slot or two different slots).
In one example, the two DCIs are received in the same slot. Three examples are shown in FIG. 23. In Example A, the two DCIs are separated by symbol(s) (in the same slot). In Example B, the two DCIs are separated by REs (in the same slot). In Example B, the two DCIs are separated by symbols and REs (in the same slot).
In one example, the two DCIs are received in two different slots. Five examples are shown in FIG. 24.
   In Example A, two triggers are received sequentially, and the CMR/IMR measurement and CSI reporting are performed in two subsequent slots in the same order.
   In Example B, trigger for CMR/IMR and CMR/IMR measurement happen first, followed by CSI trigger and CSI reporting.
   In Example C, the UE receives a CMR/IMR trigger and receives CMR/IMR measurement in a slot, and in the same slot, also receives a CSI trigger. The CSI report is reported in a later slot.
   In Example D, CSI trigger and CSI reporting happens at longer time scale that the CMR/IMR trigger and measurement.
   In Example S, CMR/IMR trigger, CMR/IMR measurement, and CSI trigger all happen in a same slot, and only CSI reporting happens in a later slot.

As explained, at least one (e.g., earlier in time) of the two triggers can be together with (multiplexed with) Msg4 or MsgB slot, or both triggers are in a slot or two slots after Msg4/MsgB slot.
In one example, a first trigger 1 is received in Msg4 or MsgB slot, and a second trigger 2 is received in a slot after Msg4/B. The first trigger 1 can trigger CMR/IMR measurement, and the second trigger 2 can trigger CSI reporting. Or, the second trigger 2 can trigger CMR/IMR measurement, and the first trigger 1 can trigger CSI reporting
In one example, a first trigger 1 is received in a slot 1 after Msg4/MsgB slot, and a second trigger 2 is received after the slot 1.

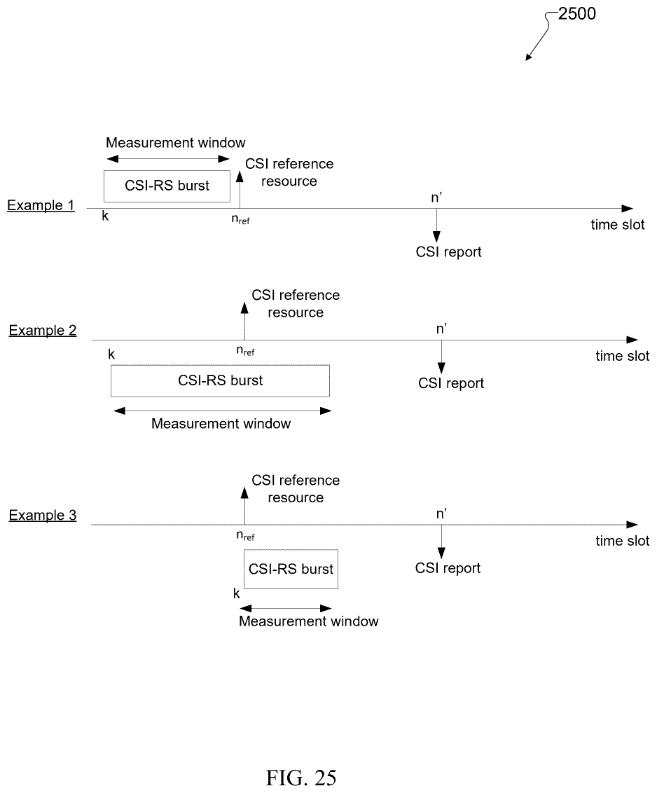

FIG. 25 illustrates an example of measuring a CSI-RS burst 2500 according to embodiments of the present disclosure. For example, the UE 116 of FIG. 3 can be configured to measure a CSI-RS burst 2500. This example is for illustration only and other embodiments can be used without departing from the scope of the present disclosure.

In one embodiment, a UE is configured to measure a CSI-RS burst, based on NZP CSI-RS resource(s) or CMR(s), within a measurement window, where the measurement window is according to at least one of the following examples

In one example, shown as example 1 in FIG. 25, both the starting slot index k and the ending slot index (k+Wₘₑₐₛ or k+Wₘₑₐₛ−1) of the measurement window are no later than n_{ref}.
In one example, the ending slot index is fixed. In one example, the ending slot index is fixed to n_{ref}, i.e., k+Wₘₑₐₛ=n_{ref} or k+Wₘₑₐₛ−1=n_{ref}. In one example, the ending slot index is fixed to the most recent, no later than n_{ref}, occasion of the CSI-RS burst(s), i.e., k+Wₘₑₐₛ=n_{ref}−δ or k+Wₘₑₐₛ−1=n_{ref}−δ, where δ>0 is a minimum integer which corresponds to the most recent, no later than n_{ref}, occasion of the CSI-RS burst(s).
In one example, the starting slot index k is fixed or configured (e.g., RRC) or determined based on the configuration of the CSI-RS burst. When fixed, k can be given by k=n_{ref}−δ δₖ. Or, k can be given by k=n′−δₖ. Here, δₖ is fixed. When configured, k can be given by k=n_{ref}−αₖ. Or, k can be given by k=n′−αₖ. Here, αₖ is configured.
In one example, both k and Wₘₑₐₛ are fixed. One of the examples described herein is used.
In one example, both k and Wₘₑₐₛ are configured (e.g., via RRC).

In one example, shown as example 2 in FIG. 25, the starting slot index k of the measurement window is no later than n_{ref} and the ending slot index (k+Wₘₑₐₛ or k+Wₘₑₐₛ−1) can be after n_{ref} but before (or no later than) n′.
In one example, the ending slot index is fixed. In one example, the ending slot index is fixed to n′, i.e., k+Wₘₑₐₛ=n′ or k+Wₘₑₐₛ−1=n′. In one example, the ending slot index is fixed to n′−δ, i.e., k+Wₘₑₐₛ=n′−δ or k+Wₘₑₐₛ−1=n′−δ, where δ>0.
In one example, the starting slot index is fixed. In one example, the starting slot index is fixed to n_{ref}, i.e., k=n_{ref}. In one example, the starting slot index is fixed to n_{ref}+δ′, where δ′≥0.
In one example, both k and Wₘₑₐₛ are fixed. One of the examples described herein is used.
In one example, both k and Wₘₑₐₛ are configured (e.g., via RRC).

In one example, shown as example 3 in FIG. 25, both the starting slot index k and the ending slot index (k+Wₘₑₐₛ or k+Wₘₑₐₛ−1) of the measurement window are no earlier than (or after) n_{ref}.
In one example, the starting slot index is fixed. In one example, the starting slot index is fixed to n_{ref}, i.e., k=n_{ref}. In one example, the starting slot index is fixed to the most first (or earliest), no earlier than n_{ref}, occasion of the CSI-RS burst(s), i.e., k=n_{ref}−δ, where δ≥0 is a minimum integer which corresponds to the first (or earliest), no earlier than n_{ref}, occasion of the CSI-RS burst(s).
In one example, the ending slot index (k+Wₘₑₐₛ or k+Wₘₑₐₛ−1) is fixed or configured (e.g., RRC) or determined based on the configuration of the CSI-RS burst. When fixed, it can be given by n′. When fixed, it can be given by n_{ref}+Ωₖ. Or, it can be given by n′−δₖ. Here, δₖ is fixed. When configured, it can be given by n_{ref}+αₖ. Or, it can be given by n′−αₖ. Here, αₖ is configured.
In one example, both k and Wₘₑₐₛ are fixed. One of the examples described herein is used.
In one example, both k and Wₘₑₐₛ are configured (e.g., via RRC).

In one example, shown as example 3 in FIG. 25, both the starting slot index k and the ending slot index (k+Wₘₑₐₛ or k+Wₘₑₐₛ−1) of the measurement window are no earlier than (or after) n_{ref}.
In one example, the starting slot index is fixed. In one example, the starting slot index is fixed to n_{ref}, i.e., k=n_{ref}. In one example, the starting slot index is fixed to the most first (or earliest), no earlier than n_{ref}, occasion of the CSI-RS burst(s), i.e., k=n_{ref}−δ, where δ≥0 is a minimum integer which corresponds to the first (or earliest), no earlier than n_{ref}, occasion of the CSI-RS burst(s).
In one example, the ending slot index (k+Wₘₑₐₛ or k+Wₘₑₐₛ−1) is fixed or configured (e.g., RRC) or determined based on the configuration of the CSI-RS burst. When fixed, it can be given by n′. When fixed, it can be given by n_{ref}+δₖ. Or, it can be given by n′−δₖ. Here, δₖ is fixed. When configured, it can be given by n_{ref}+αₖ. Or, it can be given by n′−αₖ. Here, αₖ is configured.
In one example, both k and Wₘₑₐₛ are fixed. One of the examples herein is used.
In one example, both k and Wₘₑₐₛ are configured (e.g., via RRC).

In one embodiment, a UE is configured to measure a NZP CSI-RS resource burst or NZP CSI-RS occasion(s) or measurement window [k, k+Wₘₑₐₛ−1] as described above, where k≤n_{ref} and n_{ref} is the slot index of the CSI reference resource.

If the higher layer parameter timeRestrictionForChannelMeasurements is set to “notConfigured”, the UE shall derive the channel measurements for computing CSI value reported in uplink slot n based on only the NZP CSI-RS, no later than the CSI reference resource, (defined in TS 38.211[4]) associated with the CSI resource setting.

If the higher layer parameter timeRestrictionForChannelMeasurements in CSI-ReportConfig is set to “Configured”, the UE shall derive the channel measurements for computing CSI reported in uplink slot n based on only the most recent, no later than the CSI reference resource, occasion of NZP CSI-RS (defined in [4, TS 38.211]) associated with the CSI resource setting.

If the higher layer parameter timeRestrictionForlnterferenceMeasurements is set to “notConfigured”, the UE shall derive the interference measurements for computing CSI value reported in uplink slot n based on only the CSI-IM and/or NZP CSI-RS for interference measurement no later than the CSI reference resource associated with the CSI resource setting.

If the higher layer parameter timeRestrictionForlnterferenceMeasurements in CSI-ReportConfig is set to “Configured”, the UE shall derive the interference measurements for computing the CSI value reported in uplink slot n based on the most recent, no later than the CSI reference resource, occasion of CSI-IM and/or NZP CSI-RS for interference measurement (defined in [4, TS 38.211]) associated with the CSI resource setting.

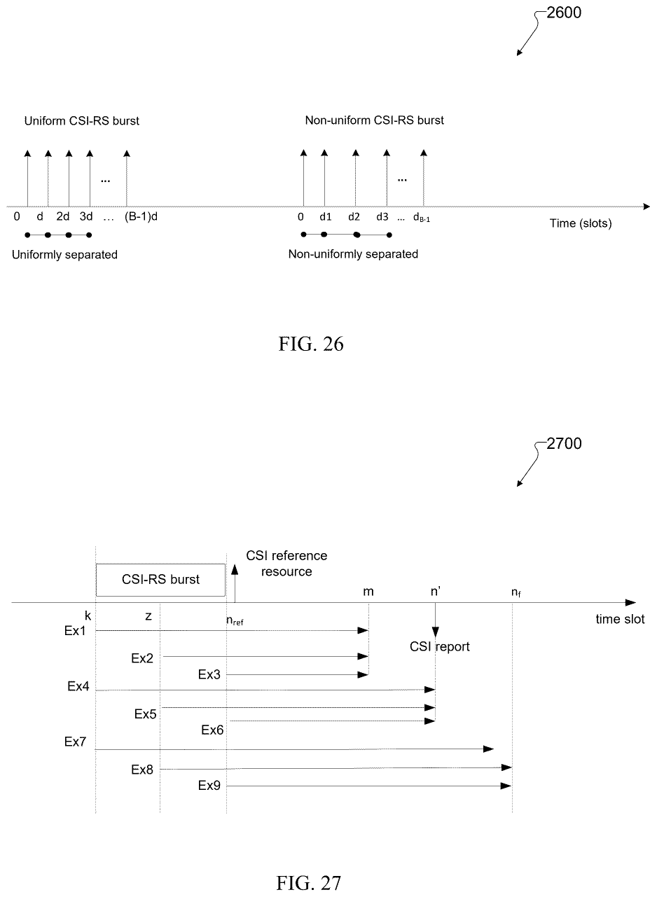

FIG. 26 illustrates an example of a timeline for a UE to receive nonzero power (NZP) CSI-RS bursts 2600 according to embodiments of the present disclosure. For example, the UE 116 of FIG. 3 can be configured to use the timeline to receive NZP CSI-RS bursts 2600. This example is for illustration only and other embodiments can be used without departing from the scope of the present disclosure.

In one example, as shown in FIG. 26, a UE is configured to receive a burst of non-zero power (NZP) CSI-RS resource(s), referred to as CSI-RS burst for brevity, in B time slots, where B≥1. The B time slots can be according to at least one of the following examples.
In one example, the B time slots are evenly/uniformly spaced with an inter-slot spacing d.
In one example, the B time slots can be non-uniformly spaced with inter-slot spacing e₁=d₁, e₂=d₂−d₁, e₃=d₃−d₂, . . . , so on, where eᵢ≠eⱼ for at least one pair (i,j) with i≠j.

The UE receives the CSI-RS burst, estimates the B instances of the DL channel measurements, and uses the channel estimates to obtain the Doppler component(s) of the DL channel. The CSI-RS burst can be linked to (or associated with) a single CSI reporting setting (e.g., via higher layer parameter CSI-ReportConfig), wherein the corresponding CSI report includes an information about the Doppler component(s) of the DL channel.

FIG. 27 illustrates an example of determining a value of N₄ 2700 according to embodiments of the present disclosure. For example, the UE 116 of FIG. 3 can be configured to determining a value of N₄ 2700. This example is for illustration only and other embodiments can be used without departing from the scope of the present disclosure.

In one example, as shown in FIG. 27, a UE is configured to determine the value of N₄ according to at least one of the following examples.
In one example (Ex1 in figure), N₄=m−k or m−k+1, where n_{ref}<m<n′.
In one example (Ex2 in figure), N₄=m−z or m−z+1, where n_{ref}<m<n′ and k<z<n_{ref}.
In one example (Ex3 in figure), N₄=m−n_{ref} or m−n_{ref}+1, where n_{ref}<m<n′.
In one example (Ex4 in figure), N₄=n′−k or n′−k+1.
In one example (Ex5 in figure), N₄=n′−z or n′−z+1, where k<z<n_{ref}
In one example (Ex6 in figure), N₄=n′−n_{ref} or n′−n_{ref}+1.
In one example (Ex7 in figure), N₄=n_{f}−k or n_{f}−k+1.
In one example (Ex8 in figure), N₄=n_{f}−z or n_{f}−z+1, where k<z<n_{ref}.
In one example (Ex9 in figure), N₄=n_{f}−n_{ref} or n_{f}−n_{ref}+1. Here, the start (slot) of W_{CSI} is n_{ref}.
In one example, N₄=W_{CSI}=n_{f}−n′ or n_{f}−n′+1. Here, the start (slot) of W_{CSI} is n′.
In one example, N₄=W_{CSI},R_{ST}=(n_{f}−n′)R_{ST} or (n_{f}−n′+1) R_{ST} where R_{ST}≥1 or <1. The value of R_{ST} can be fixed, or configured (e.g., via RRC or MAC CE or DCI). The location of the N₄ TD/DD units corresponds to the CSI reporting/validity window. Here, the start (slot) of W_{CSI} is n′. When R_{ST}≤1, we can write

$${R}_{ST} = \frac{1}{d}$$

where d is a positive integer taking values from {1,2,3, . . . }, and in this case, W_{CSI}=dN₄.
In one example, N₄=W_{CSI}R_{ST}=(n_{f}−n_{ref})R_{ST} or (n_{f}−n_{ref}+1)R_{ST} where R_{ST}>1 or <1. The value of R_{ST} can be fixed, or configured (e.g., via RRC or MAC CE or DCI). The location of the N₄ TD/DD units corresponds to the CSI reporting/validity window. Here, the start (slot) of W_{CSI} is n_{ref}. When R_{ST}<1, we can write

$${R}_{ST} = \frac{1}{d}$$

where d is a positive integer taking values from {1,2,3, . . . }, and in this case, W_{CSI}=dN₄.
In one example, N₄=W_{CSI}=n_{f}−1 or n_{f}−l+1, where n′<l or n′≤l. Here, the start (slot) of W_{CSI} is 1. The value of 1 can be fixed, or configured (e.g., via RRC or MAC CE or DCI).
In one example, N₄=W_{CSI}R_{ST}=(n_{f}−l)R_{ST} or (n_{f}−l+1)R_{ST} where R_{ST}≥1 or <1, and n′<l or n′≤l. Here, the start (slot) of W_{CSI} is 1. The value of 1 can be fixed, or configured (e.g., via RRC or MAC CE or DCI). The value of R_{ST} can be fixed, or configured (e.g., via RRC or MAC CE or DCI). The location of the N₄ TD/DD units corresponds to the CSI reporting/validity window. When R_{ST}<1, we can write

$${R}_{ST} = \frac{1}{d}$$

where d is a positive integer taking values from {1,2,3, . . . }, and in this case, W_{CSI}=dN₄. ° In one example, the start (slot) of W_{CSI} is either n_{ref} or l, and one of the two is configured via higher layer signaling. In one example, l=n′+δ, where δ≥0. In one example, δ is fixed (e.g., 0), or is configured via higher-layer (RRC) signaling from {0, 1, 2, 3, 4, 6, 8}. In one example, δ is configured via higher-layer (RRC) signaling from S={0, 2, v}, where v is an additional value. In one example, the additional value of according to one of the following examples
   In one example, v=1, implying S={0,1,2}.
   In one example, v=3, implying S={0,2,3}.
   In one example, v=4, implying S={0,2,4}.
   In one example, v=5, implying S={0,2,5}.
In one example, when n_{ref}=n′−n_{CSI,ref}, the previous example is equivalent to the following. The start (slot) of W_{CSI} is l=n′+δ, where δ≥0 or δ=−n_{CSI,ref}. In one example, δ is fixed (e.g., 0 or −n_{CSI,ref}), or is configured via higher-layer (RRC) signaling from {−n_{CSI,ref}, 0, 1, 2, 3, 4, 6, 8}. In one example, δ is configured via higher-layer (RRC) signaling from S={−n_{CSI,ref}, 0, 2, v}, where v is an additional value. In one example, the additional value of according to one of the following examples
   In one example, v=1, implying S={0,1,2}.
   In one example, v=3, implying S={0,2,3}.
   In one example, v=4, implying S={0,2,4}.
   In one example, v=5, implying S={0,2,5}.

The channel measurement can be based on K>1 channel measurement resources (CMRs) that are transmitted from a plurality of spatial-domain (SD) units (e.g., a SD unit=a CSI-RS antenna port), and are measured via a plurality of frequency-domain (FD) units (e.g., a FD unit=one or more PRBs/SBs) and via either a time-domain (TD) unit or a plurality of TD units (e.g., a TD unit=one or more time slots). In one example, a CMR can be an NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) and/or a second set of TD units (different from the plurality of TD units associated with the channel measurement). In this later case, the UE, based on the channel measurement, can perform prediction (interpolation or extrapolation) in the second set of FD units and/or the second set of TD units associated with the CSI report.

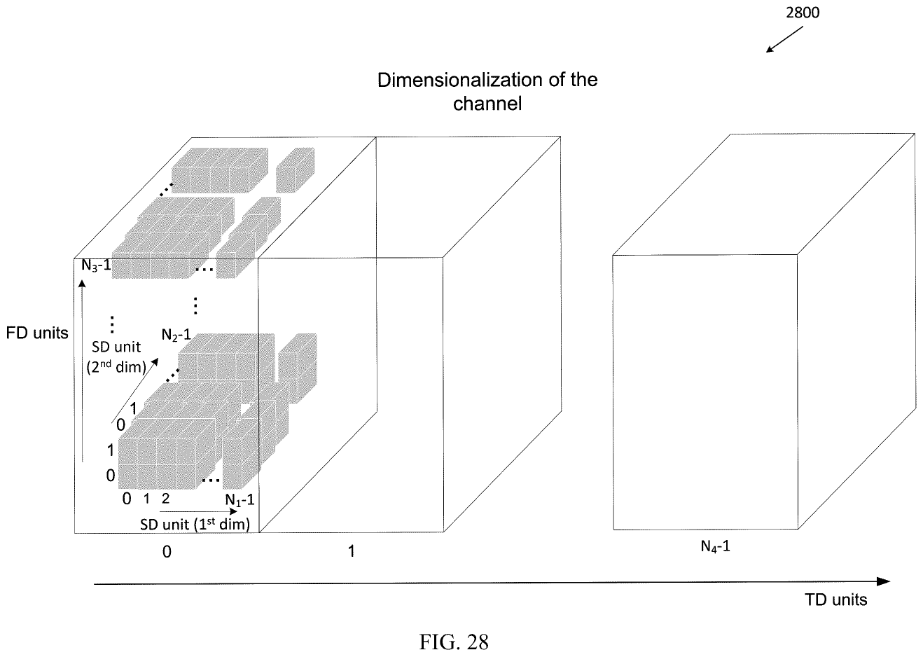

FIG. 28 illustrates a timeline of example spatial-domain (SD) units and frequency-domain (FD) units 2800 according to embodiments of the present disclosure. For example, the UE 116 of FIG. 3 can be configured to use the timeline of example spatial-domain (SD) units and frequency-domain (FD) units 2800. This example is for illustration only and other embodiments can be used without departing from the scope of the present disclosure.

An illustration of the SD units (in 1^{st} and 2^{nd} antenna dimensions), FD units, and, and TD units is shown in FIG. 22.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

In one example, N₄ is restricted to be N₄=1 for early CSI report (a CSI report while undergoing or right after completing the RACH procedure), as described earlier.

The plurality of SD units can be associated with antenna ports (e.g., co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG comprising all P_{CSIRS} ports, and the CSI report is based on the channel measurement from the one PG.
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG (one-to-one mapping). In one example, multiple CMRs can correspond to an PG (many-to-one mapping). In one example, K>1 CMRs comprise a measurement burst, as described later in the disclosure. In one example, when K>1, the measures K CMRs, and selects one of them, and determines the CSI report for the selected CMR. The CSI report can include an indicator to indicate the selected CMR. In one example, when K>1, the UE measures them and determines the CSI report that either includes CSI for each of the measured K CMRs or includes a CJT CSI assuming a CJT transmission hypothesis. In one example, when K>1, the measures K CMRs, and selects a subset 1≤k<K of them, and determines the CSI report for the selected CMRs. The CSI report can include an indicator or indicators to indicate the selected CMR(s). The determined CSI can either include CSI for each of the selected k CMR(s) or include a CJT CSI assuming a CJT transmission hypothesis across selected CMRs.

In one example, when all of the P_{CSIRS} antenna ports are co-located at one site, N_{g}=1. In one example, when all of the P_{CSIRS} antenna ports are distributed (non-co-located) across multiple sites, N_{g}>1.

In one example, when all of the P_{CSIRS} antenna ports are co-located at one site and within a single antenna panel, N_{g}=1. In one example, when all of the P_{CSIRS} antenna ports are distributed across multiple antenna panels (can be co-located or non-co-located), N_{g}>1.

The value of N_{g} can be configured, e.g., via higher layer RRC parameter. Or, it can be indicated via a MAC CE. Or, it can be provided via a DCI field.

Likewise, the value of K can be configured, e.g., via higher layer RRC parameter. Or, it can be indicated via a MAC CE. Or, it can be provided via a DCI field.

In one example, K=N_{g}=X. The value of X can be configured, e.g., via higher layer RRC parameter. Or, it can be indicated via a MAC CE. Or, it can be provided via a DCI field.

In one example, the value of K is determined based on the value of N_{g}. In one example, the value of N_{g} is determined based on the value of K.

In one example, K is restricted to be K=1 for early CSI report (a CSI report while undergoing or right after completing the RACH procedure), as described earlier.

In one example, P_{CSIRS} is restricted to be P_{CSIRS}ϵS or P_{CSIRS}≤t or P_{CSIRS}<t for early CSI report (a CSI report while undergoing or right after completing the RACH procedure), as described earlier.
In one example, the set S includes only one value, e.g., {2}.
In one example, the set S includes only two values, e.g., {1,2} or {2,4}.
In one example, the set S includes only 3 values, e.g., {1, 2,4} or {2, 4,8}.
In one example, the threshold t is fixed (e.g., 2 or 4 or 8).
In one example, the threshold t is based on UE capability reporting (e.g., 2 or 4 or 8), e.g., as part of Msg1 or MsgA.

The plurality of FD units can be associated with a frequency domain allocation of resources (e.g., one or multiple CSI reporting bands, each comprising multiple PRBs) and dimensionalizes the frequency (or delay)-domain profile of the channel measurement.

The plurality of TD units can be associated with a time domain allocation of resources (e.g., one or multiple CSI reporting windows, each comprising multiple time slots) and dimensionalizes the time (or Doppler)-domain profile of the channel measurement.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2KN₁N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is

$${P}_{CSIRS , tot} = {\sum }_{r = 1}^{K} 2 {N}_{1 , r} {N}_{2 , r} .$$

In port numbering scheme 1, the CSI-RS ports are numbered according to the order of (polarization p, NZP CSI-RS resource r) as CSI-RS ports of (p=0, r=1) followed by CSI-RS ports of (p=1,r=1), followed by CSI-RS ports of (p=0,r=2), followed by CSI-RS ports of (p=1,r=2), . . . , followed by CSI-RS ports of (p=0, r=N) followed by CSI-RS ports of (p=1,r=N).

In port numbering scheme 2, the CSI-RS ports are numbered according to the order of (polarization p, NZP CSI-RS resource r) as
CSI-RS ports of (p=0, r=1) followed by CSI-RS ports of (p=0, r=1), . . . , followed by CSI-RS ports of (p=0, r=N), and
then CSI-RS ports of (p=1, r=1) followed by CSI-RS ports of (p=1, r=1), . . . , followed by CSI-RS ports of (p=1, r=N).

In one example, an PG corresponds to an antenna, an antenna group (multiple antennae), an antenna port, an antenna port group (multiple ports), a CSI-RS resource, a CSI-RS resource set, a group of CSI-RS resources, a panel, an RRH, a Tx-Rx entity, a (analog) beam, a (analog) beam group, a cell, a cell group.

In one example, PGs can have a uniform (the same/common) structure. For example, they can have the same number of ports (P_{CSIRS,r}−P_{CSIRS}) or the same antenna port layout (N_{1,r}, N_{2,r})=(N₁, N₂). In one example, PGs can have non-uniform (or different) structure. For example, they can have the same or different number of ports (P_{CSIRS,r}_{₁}=P_{CSIRS,r}_{₂} or P_{CSIRS,r}_{₁}≠P_{CSIRS,r}_{₂}) or the same antenna port layout, i.e., (N_{1,r}_{₁}, N_{2,r}_{₁}) (N_{1,r}_{₂}, N_{2,r}_{₂}) or (N_{1,r}_{₁},N_{2,r}_{₁})≠(N_{1,r}_{₂}, N_{2,r}_{₂}).

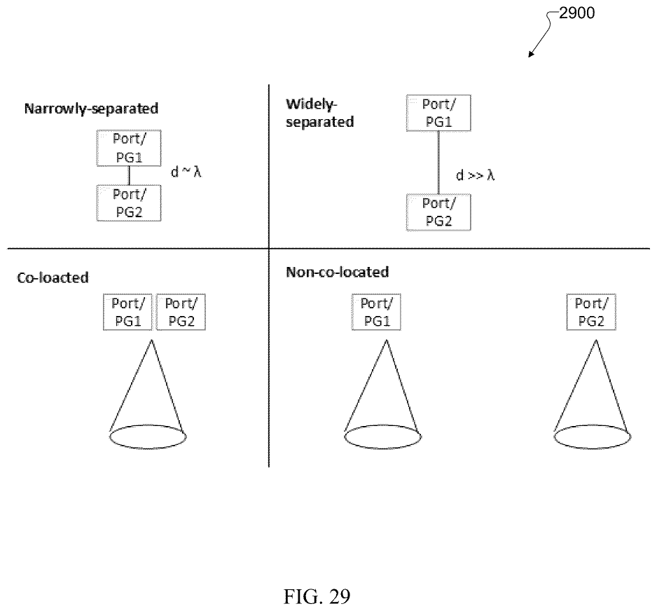

FIG. 29 illustrates an example antenna port-based/PG-based layout 2900 according to embodiments of the present disclosure. For example, antenna port-based/PG-based layout 2900 can be implemented in the wireless network 100 of FIG. 1. This example is for illustration only and can be used without departing from the scope of the present disclosure.

In one embodiment, a UE is configured with a CSI report (e.g., trigger state or a CSI report setting via higher layer IE CSI-AperiodicTriggerState or CSI-ReportConfig) based on a port-based/PG-based framework, wherein the CSI report is based on a measurement configuration (e.g., CSI-ResourceConfig or CSI-MeasurementConfig or CSI-PGConfig or CSI-PortConfig).

The measurement configuration includes a configuration for channel measurement, which can be according to one of the following examples.
In one example, the channel measurement corresponds to measuring P_{CSIRS} CSI-RS ports.
In one example, the channel measurement corresponds to measuring N_{g}≥1 PGs, where a PG g=1 . . . , N_{g} includes P_{CSIRS,r} CSI-RS ports.
In one example, the channel measurement corresponds to measuring the Q_{CSIRS} ports or M. PGs indicated dynamically (E.g., via DCI and/or MAC CE), where the Q_{CSIRS} ports or M_{g} PGs respectively are from the configured the P_{CSIRS} ports or N_{g} PGs. The dynamic indication can facilitate turning ports or PGs ON/OFF (e.g., for energy saving purpose).

As shown in FIG. 29, the ports/PGs can be narrowly-spaced or widely-spaced with compared with the wavelength A of the (center) carrier of the frequency band associated with the CSI report. Or, the ports/PGs can be col-located (at physical location) or non-co-located (at different physical locations).

The measurement configuration can also include a configuration for interference measurement.
In one example, the interference measurement corresponds to measuring I_{IMR} CSI-IMR ports. In one example, I_{IMR}=P_{CSIRS}. In one example, I_{IMR}=1.
In one example, the interference measurement corresponds to measuring I_{g}≥1 PGs, where a PG r=1 , . . . , I_{g} includes I_{IMR,r} CSI-IMR ports. In one example, I_{g}=N_{g}. In one example, I_{g}=1. In one example, I_{IMR,r}=P_{CSIRS,r}. In one example, I_{IMR,r}=1.

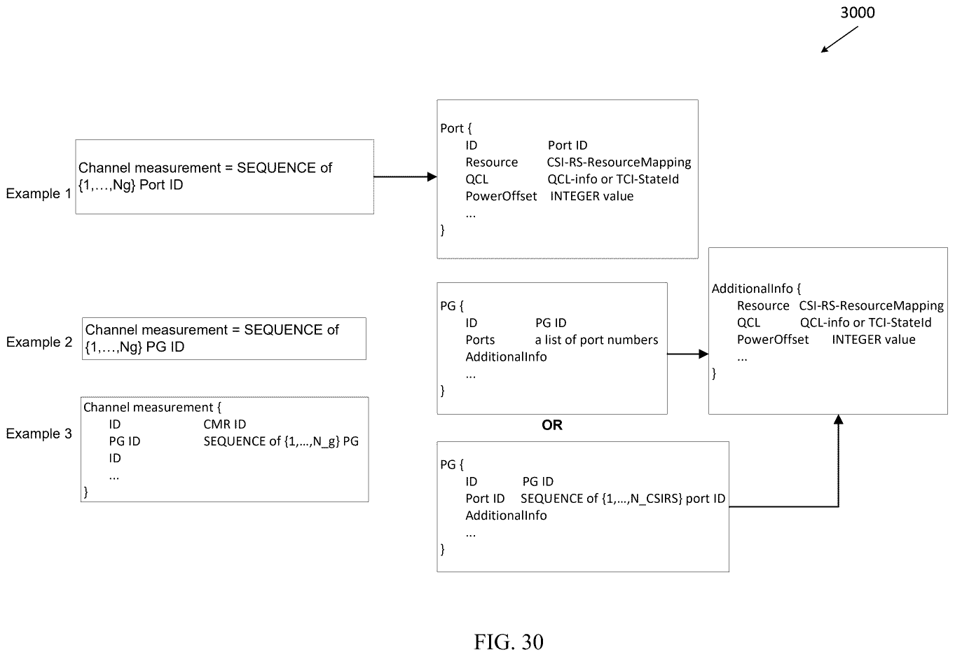

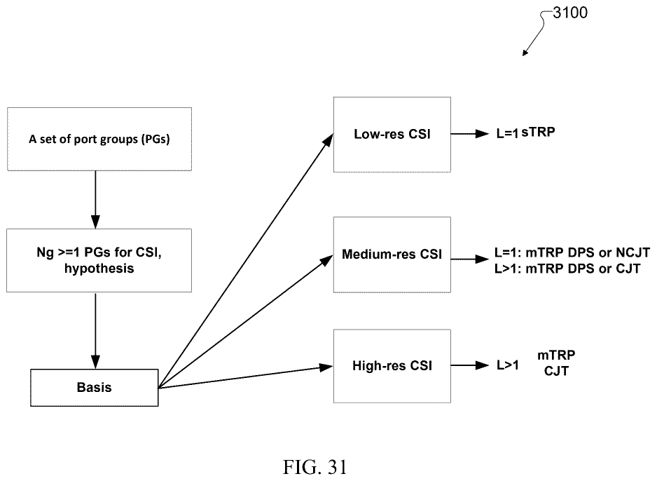

FIG. 30 illustrates an example configuration for channel measurement 3000 according to embodiments of the present disclosure. For example, the UE 116 of FIG. 3 can be configured to use the channel measurement 3000. This example is for illustration only and other embodiments can be used without departing from the scope of the present disclosure.

In one example, a configuration for channel measurement includes at least one of the following:
In one example, a configuration for channel measurement includes a list (or sequence) of port IDs, where a port ID indicates an information (e.g., IE) about a port for measurement. Example 1 in FIG. 30 is an example.
In one example, a configuration for channel measurement includes an ID of a PG (e.g., PG ID) or a sequence of N_{g}>1 IDs (e.g., each is a PG ID). Example 2 and 3 in FIG. 30 are two examples.
In one example, a configuration for channel measurement includes a list of port numbers (e.g., for CSI-RS, port numbers are from {3000, 3001, 3002, . . . }).

In one example, the UE receives a trigger message (e.g., which indicates a CSI-TriggerState) for aperiodic (AP) reporting of the CSI report. In one example, the trigger message is received via a DCI (e.g., CSI request field in an UL-related DCI or a CSI request field in a DL-related DCI or a CSI request field in a dedicated or special purpose DCI that is different from DL-related DCI or UL-related DCI). Here, DCI-related DCI corresponds to a DCI (format) that allocates DL PDSCH assignment, and UL-related DCI corresponds to a DCI (format) that grants UL PUSCH transmission.

In one example, the UE initiates/triggers the measurement/reporting by transmitting a message/request to the NW. The message/request acts as a trigger (e.g., which indicates a CSI-TriggerState) for the AP reporting of the CSI report. In one example, the message/request is via a layer 1 signaling such as scheduling request (SR) or UCI. In this example, higher layer RRC (and/or MAC CE) is used to configure (and activate) one or more than one AP CSI trigger states, and SR/UCI with the message/request acts as a trigger (without any indication from NW). The UL resource allocation (RA) for CSI report can be pre-configured (CG PUSCH), or granted after the UE-initiated trigger/request is received.

In one example, the UE initiates/triggers the measurement/reporting by transmitting a message/request to the NW. The message/request acts as a trigger (e.g., which indicates a CSI-TriggerState) for the AP reporting of the CSI report. The UE then receives an ACK (e.g., 1-bit in DCI), and then performs measurement and reporting of the CSI report. In one example, the message/request is via a layer 1 signaling such as scheduling request (SR) or UCI. In this example, higher layer RRC (and/or MAC CE) is used to configure (and activate) one or more than one AP CSI trigger states, and SR/UCI with the message/request acts as a trigger or activator and the ACK from the NW allows/initiates the CSI reporting procedure. The UL resource allocation (RA) for CSI report can be pre-configured (CG PUSCH), or granted (e.g., together with ACK).

In a variation of the previous example, a first DCI (as explained above) can dynamically change/adapt information about the measurement (e.g., number of ports, power level etc.) associated with the CSI report, but does not trigger the CSI report. The trigger is UE-initiated. The NW can ACK in response to the UE-initiated trigger/request via a second DCI, and then the UE measures and reports the CSI report according to the latest update (if any) of the CSI Trigger state (via the first DCI). In one example, the first DCI and the second DCI are the same. In one example, they can be different.

FIG. 31 illustrates an example of configuring a UE with a codebook for PMI calculation and reporting 3100 according to embodiments of the present disclosure. For example, the UE 116 of FIG. 3 can be configured with a codebook for PMI calculation and reporting 3100. This example is for illustration only and other embodiments can be used without departing from the scope of the present disclosure.

In one embodiment, the UE is further configured with a codebook for PMI calculation and reporting, where the codebook includes at least two components; (a) basis and (b) coefficients, as shown in 31. The basis includes L vectors (or matrices) associated with SD (across SD units such as ports and/or PGs). Additionally, the basis can also include M vectors (or matrices) associated with FD (across FD units such as PRBs or SBs), and/or Q vectors (or matrices) associated with TD/DD (across TD/DD units such as time slots). The parameter (L, M, Q) can be fixed or configured (e.g., via higher layer parameter).

In one example, when L=1, the codebook corresponds to a low-resolution codebook based on a single vector, and when L>1, the codebook corresponds a high-resolution codebook based on a linear combination of multiple vectors.

When M is not provided/configured, there is no FD basis, i.e., there is no compression in FD, and hence the PMI component (i₂) for the co-phase and/or amplitude of the coefficients are reported for each SB in the CSI reporting band. When M is provided, there is FD compression across FD PRBs (cf. Rel-16 eType II codebook in 5G NR).

When Q is not provided/configured, there is no TD/DD basis, i.e., there is no compression in TD/DD. When Q is provided, there is TD/DD compression across TD/DD units or time slots (cf. Rel-18 eType II-Doppler codebook in 5G NR).

In one example, the basis vectors are DFT vectors. In one example, the basis vectors are orthogonal DFT vectors without oversampling or rotation factor (i.e., the DFT vectors are critically sampled, i.e., oversampling factor=1). In one example, the basis vectors are orthogonal DFT vectors with oversampling or rotation factor (i.e., the DFT vectors are oversampled with oversampling factor>1, e.g., 4). In one example, the SD basis vectors are orthogonal DFT vectors with oversampling or rotation factor=4. In one example, the FD or DD/TD basis vectors are orthogonal DFT vectors without oversampling or rotation factor.

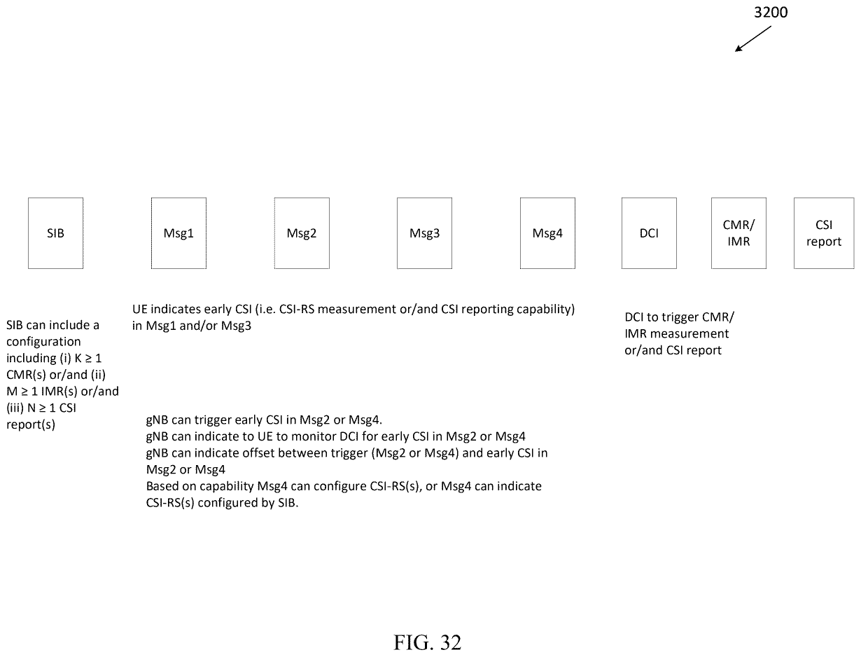

FIG. 32 illustrates an example procedure 3200 for early CSI according to embodiments of the present disclosure. For example, the UE 113 and the network 130 and/or the BS 103 of FIG. 1 can implement the procedure 3200 for early CSI. This example is for illustration only and other embodiments can be used without departing from the scope of the present disclosure.

As shown in FIG. 32, the SIB can include a configuration including (i) K≥1 CMR(s) and/or (ii) M≥1 IMR(s) and/or (iii) N>1 CSI report(s) SIB can include a configuration including (i) K≥1 CMR(s) and/or (ii) M≥1 IMR(s) and/or (iii) N≥1 CSI report(s). The UE can indicate early CSI (i.e., CSI-RS measurement and/or CSI reporting capability) in Msg1 and/or Msg3. The DCI can be used to trigger the CMR/IMR measurement and/or CSI report. The gNB can trigger early CSI in Msg2 or Msg4. The gNB can indicate to the UE to monitor DCI for early CSI in Msg2 or Msg4. The gNB can indicate an offset between the trigger (Msg2 or Msg4) and early CSI in Msg2 or Msg4. Based on capability Msg4, the gNB can configure CSI-RS(s), or Msg4 can indicate CSI-RS(s) configured by SIB.

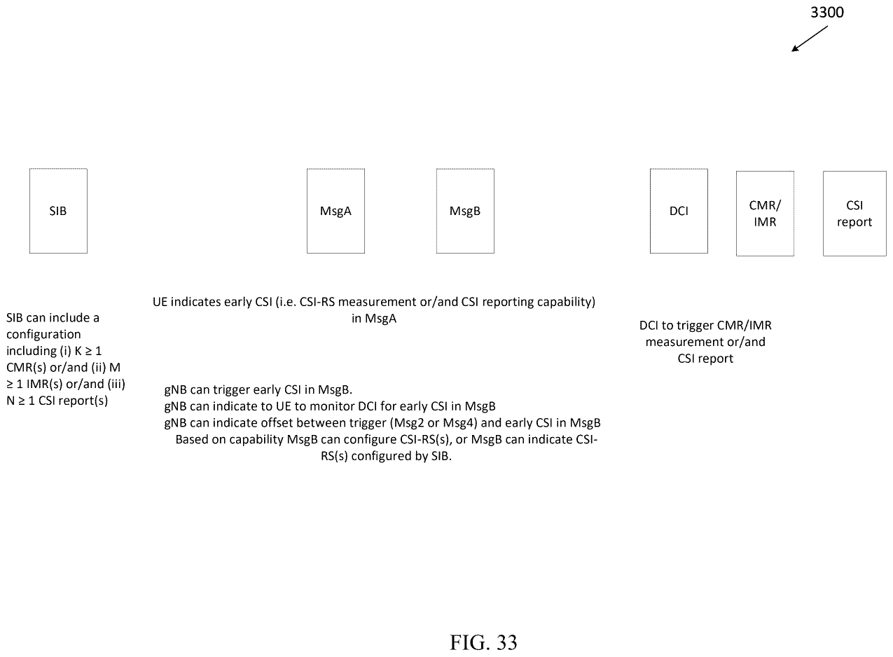

FIG. 33 illustrates another example procedure 3300 for early CSI according to embodiments of the present disclosure. For example, the UE 113 and the network 130 and/or the BS 103 of FIG. 1 can implement the procedure 3300 for early CSI. This example is for illustration only and other embodiments can be used without departing from the scope of the present disclosure.

As shown in FIG. 33, the SIB can include a configuration including (i) K>1 CMR(s) and/or (ii) M>1 IMR(s) and/or (iii) N>1 CSI report(s) SIB can include a configuration including (i) K>1 CMR(s) and/or (ii) M>1 IMR(s) and/or (iii) N>1 CSI report(s). The UE can indicate early CSI (i.e., CSI-RS measurement and/or CSI reporting capability) in MsgA. The DCI can be used to trigger the CMR/IMR measurement and/or CSI report. The gNB can trigger early CSI in MsgB. The gNB can indicate to the UE to monitor DCI for early CSI in MsgB. The gNB can indicate an offset between the trigger and early CSI in MsgB. Based on capability MsgB, the gNB can configure CSI-RS(s), or MsgB can indicate CSI-RS(s) configured by SIB.

In the present disclosure, the term “CMR” is used as an acronym for channel measurement resource. In one example, a CMR can be an NZP CSI-RS (resource), or SSB, or DL DMRS.

In this disclosure, the term “IMR” is used as an acronym for interference measurement resource. In one example, a IMR can be an NZP CSI-RS (resource), or ZP CSI-RS (resource), or a CSI-IM.

In the present disclosure, a CSI is always associated with at least one CMR and/or IMR, that is received and measured by the UE in a slot no later than or earlier than the CSI reporting slot (in which the CSI is reported).

In the present disclosure, an early CSI refers to configurations in which the CMR/IMR measurement and/or CSI reporting are performed as early as possible, e.g., (partially) together with a RACH procedure, or right after (the earliest possible slot) the RACH procedure. The early CSI can be configured to an IDLE or INACTIVE UE such that while the UE wakes up or undergoes RACH procedure, the CMR/IMR measurement and CSI report can proceed in parallel or as soon as possible so that the UE can be served with minimum delay once the UE established RRC connection with the NW.

In the present disclosure, the term “early CSI” includes at least one of: (a) reception of at least one CMR and/or IMR for channel and/or interference measurement, respectively, and (b) transmission of at least one CSI, where the at least one CSI is determined based on the measurement of the at least one CMR and/or IMR.

In one example, a UE transmits, via a RACH preamble, its capability to support (for receiving) CMR/IMR and (transmitting) CSI report. In one example, a UE can be configured by system information (SIB) with at least one CMR/IMR(s). In one example, a UE can be configured by a PEI and/or a paging message with at least one CMR/IMR(s). In one example, a UE can be configured by Msg2 or MsgA with at least one CMR/IMR(s).

In one example, a UE can transmit a preamble, wherein the preamble (Msg1) indicates support of early CSI. In response to the preamble (Msg1), network can transmit a DCI format or PDSCH (e.g., carrying MAC CE) that trigger early CSI, following the aforementioned examples in this disclosure. In one example the network can indicate in the SIB, whether or not the network supports DCI format or PDSCH (e.g., carrying MAC CE) for triggering early CSI.

In one example, the early CSI is associated with a RACH scheduling DL transmission or a Msg2. In one example, a UE can be configured by system information to receive the at least one CMR (e.g., NZP CSI-RS(s)) or at least one IMR (e.g., CSI-IM(s)) associated with or after a Msg2. In one example, a UE can be indicated by a PEI and/or a paging message to receive the at least one CMR (e.g., NZP CSI-RS(s)) or at least one IMR (e.g., CSI-IM(s)) associated with or after a Msg4. In one example, a UE can be indicated by a RAR to receive the at least one CMR (e.g., NZP CSI-RS(s)) or at least one IMR (e.g., CSI-IM(s)) associated with or after a Msg2.

In one example, a UE can transmit a Msg3, wherein the Msg3 indicates support of early CSI. In one example, a UE can transmit a preamble (Msg1) and Msg3, wherein the preamble (Msg1) and Msg3 indicate support of early CSI. In response to the preamble (Msg1) and/or Msg3, network can transmit a DCI format or PDSCH (e.g., carrying MAC CE) that triggers early CSI, following the aforementioned examples. In one example the network can indicate in the SIB, whether or not the network supports DCI format or PDSCH (e.g., carrying MAC CE) for triggering early CSI.

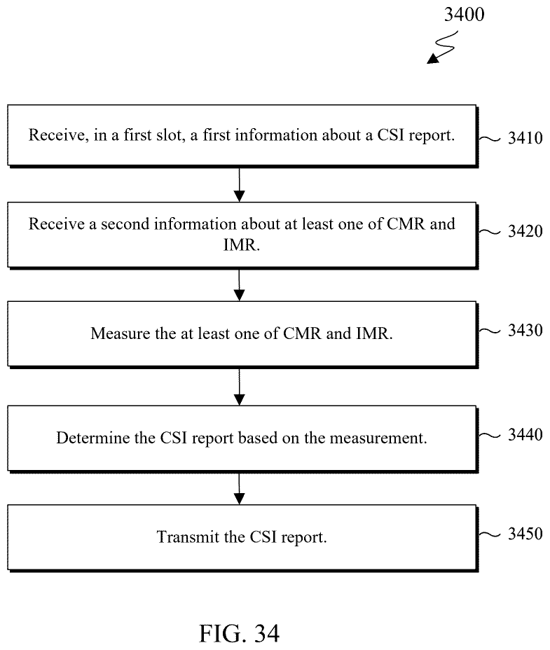

FIG. 34 illustrates an example method 3400 performed by a UE in a wireless communication system according to embodiments of the present disclosure. The method 3400 of FIG. 34 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3400 is for illustration only and other embodiments can be used without departing from the scope of the present disclosure.

The method 3400 begins with the UE receiving, in a first slot, a first information about a CSI report (3410). In various embodiments, the first slot is a second slot or D slots after the second slot, where D>0, and the second slot is associated with a last step of an N-step RACH procedure, where Nϵ{2,4}. In various embodiments, when N=4, the last step includes a message 4 of a four-step RACH procedure comprising messages 1, 2, 3, and 4. In various embodiments, when N=2, the last step includes a message B of a two-step RACH procedure comprising messages A and B. In various embodiments, D is fixed or configured via the last step of the N-step RACH procedure.

The UE then receives a second information about at least one of CMR and IMR (3420). In various embodiments, the second information is received in the first slot via a joint trigger including the first and second information or two separate triggers, one including the first information and another including the second information. In various embodiments, the second information is received in a slot that is different from the first slot.

The UE then measures the at least one of CMR and IMR (3430). In various embodiments, the at least one of CMR and IMR is measured in the first slot. The UE then determines the CSI report based on the measurement (3440). In various embodiments, the at least one of CMR and IMR is measured in a CSI reference resource slot, and the CSI report is determined for the CSI reference resource slot or for a slot that is at least one slot after the CSI reference resource slot. The UE then transmits the CSI report (3450).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive, in a first slot, a first information about a channel state information (CSI) report, and
receive a second information about at least one of channel measurement reference signal (CMR) and interference measurement reference signal (IMR); and
a processor operably coupled to the transceiver, the processor configured to:
measure the at least one of CMR and IMR, and
determine the CSI report based on the measurement,
wherein the transceiver is further configured to transmit the CSI report,
wherein the first slot is (i) a second slot or (ii) D slots after the second slot, where D>0, and
wherein the second slot is associated with a last step of an N-step random access channel (RACH) procedure, where Nϵ{2,4}.

2. The UE of claim 1, wherein:
when N=4, the last step includes a message 4 of a four-step RACH procedure comprising messages 1, 2, 3, and 4, and
when N=2, the last step includes a message B of a two-step RACH procedure comprising messages A and B.

3. The UE of claim 1, wherein D is fixed or configured via the last step of the N-step RACH procedure.

4. The UE of claim 1, wherein the second information is received in the first slot via (i) a joint trigger including the first and second information or (ii) two separate triggers, one including the first information and another including the second information.

5. The UE of claim 4, wherein the at least one of CMR and IMR is measured in the first slot.

6. The UE of claim 1, wherein the second information is received in a slot that is different from the first slot.

7. The UE of claim 1, wherein:
the at least one of CMR and IMR is measured in a CSI reference resource slot, and
the CSI report is determined for the CSI reference resource slot or for a slot that is at least one slot after the CSI reference resource slot.

8. A base station (BS), comprising:
a processor; and
a transceiver operably coupled to the processor, the transceiver configured to:
transmit, in a first slot, a first information about a channel state information (CSI) report;
transmit a second information about at least one of channel measurement reference signal (CMR) and interference measurement reference signal (IMR);
transmit the at least one of CMR and IMR; and
receive the CSI report that is based on the at least one of CMR and IMR,
wherein the first slot is (i) a second slot or (ii) D slots after the second slot, where D>0, and
wherein the second slot is associated with a last step of an N-step random access channel (RACH) procedure, where Nϵ{2,4}.

9. The BS of claim 8, wherein:
when N=4, the last step includes a message 4 of a four-step RACH procedure comprising messages 1, 2, 3, and 4, and
when N=2, the last step includes a message B of a two-step RACH procedure comprising messages A and B.

10. The BS of claim 8, wherein D is fixed or configured via the last step of the N-step RACH procedure.

11. The BS of claim 8, wherein the second information is transmitted in the first slot via (i) a joint trigger including the first and second information or (ii) two separate triggers, one including the first information and another including the second information.

12. The BS of claim 11, wherein the at least one of CMR and IMR is transmitted in the first slot.

13. The BS of claim 8, wherein the second information is transmitted in a slot that is different from the first slot.

14. The BS of claim 8, wherein:
the at least one of CMR and IMR is transmitted in a CSI reference resource slot, and
the CSI report is for the CSI reference resource slot or for a slot that is at least one slot after the CSI reference resource slot.

15. A method performed by a user equipment (UE), the method comprising:
receiving, in a first slot, a first information about a channel state information (CSI) report;
receiving a second information about at least one of channel measurement reference signal (CMR) and interference measurement reference signal (IMR);
measuring the at least one of CMR and IMR;
determining the CSI report based on the measurement; and
transmitting the CSI report,
wherein the first slot is (i) a second slot or (ii) D slots after the second slot, where D>0, and
wherein the second slot is associated with a last step of an N-step random access channel (RACH) procedure, where Nϵ{2,4}.

16. The method of claim 15, wherein:
when N=4, the last step includes a message 4 of a four-step RACH procedure comprising messages 1, 2, 3, and 4, and
when N=2, the last step includes a message B of a two-step RACH procedure comprising messages A and B.

17. The method of claim 15, wherein D is fixed or configured via the last step of the N-step RACH procedure.

18. The method of claim 15, wherein the second information is received in the first slot via (i) a joint trigger including the first and second information or (ii) two separate triggers, one including the first information and another including the second information.

19. The method of claim 18, wherein the at least one of CMR and IMR is measured in the first slot.

20. The method of claim 15, wherein the second information is received in a slot that is different from the first slot.
